(19) United States
(12) Patent Application Publication
(10) Pub. No.: US 2012/0254251 A1
(43) Pub. Date: Oct. 4, 2012

(54) SYSTEMS AND METHODS FOR EFFICIENT TOP-k APPROXIMATE SUBTREE MATCHING

(75) Inventors: Denilson Barbosa, Edmonton (CA); Nikolaus Augsten, Bozen-Bolzano (IT); Michael Böhlen, Zurich (CH); Themis Palpanas, Trento (IT)

(73) Assignee: THE GOVERNORS OF THE UNIVERSITY OF ALBERTA, Edmonton (CA)

(21) Appl. No.: 13/411,494

(22) Filed: Mar. 2, 2012

Related U.S. Application Data
(60) Provisional application No. 61/448,996, filed on Mar. 3, 2011.

(30) Foreign Application Priority Data
Mar. 3, 2011 (CA) 2733311

(51) Int. Cl. G06F 17/30

(52) U.S. Cl. 707/797; 707/E17.012

(57) ABSTRACT

Systems and method for searching for approximate matches in a database of documents represented by a tree structure. A fast solution to the Top-k Approximate Subtree Matching Problem involves determining candidate subtrees which will be considered as possible matches to a query also represented by a tree structure. Once these candidate subtrees are found, a tree edit distance between each candidate subtree and the query tree is calculated. The results are then sorted to find those with the lowest tree edit distance.

### TECHNICAL FIELD

The present invention relates to computer-based searching of databases. More specifically, the present invention relates to a tree-based searching method for finding a set of closest approximations in a database to a query.

### BACKGROUND OF THE INVENTION

Repositories of XML documents have become popular and widespread. Along with this development has come the need for efficient techniques to approximately match XML trees based on their similarity according to a given distance metric. Approximate matching is used for integrating heterogeneous repositories, cleaning such integrated data, as well as for answering similarity queries. For these applications, the issue is the so-called Top-k Approximate Subtree Matching problem (TASM), i.e., the problem of ranking the k best approximate matches of a small query tree in a large document tree. More precisely, given two ordered labeled trees, a query Q of size m and a document T of size n, what is sought is a ranking (Tᵢ1, Tᵢ2, . . . , Tᵢk) of k subtrees of T (consisting of nodes of T with their descendants) that are closest to Q with respect to a given metric.

The naive solution to TASM computes the distance between the query Q and every subtree in the document T, thus requiring n distance computations. Using the well-established tree edit distance as a metric, the naive solution to TASM requires O(m²n²) time and O(mn) space. An O(n) improvement in time leverages the dynamic programming formulation of tree edit distance algorithms: compute the distance between Q and T, and rank all subtrees of by visiting the resulting memorization table. Still, for large documents with millions of nodes, the O(mn) space complexity is prohibitive.

Answering top K queries is an active research field. Specific to XML, many authors have studied the ranking of answers to twig queries, which are XPath expressions with branches specifying predicates on nodes (e.g., restrictions on their tag names or content) and structural relationships between nodes (e.g., ancestor-descendant). Answers (respectively, approximate answers) to a twig query are subtrees of the document that satisfy (respectively, partially satisfy) the conditions in the query. Answers are ranked according to the restrictions in the query that they violate. Approximate answers are found by explicitly relaxing the restrictions in the query through a set of predefined rules. Relevant subtrees that are similar to the query but do not fit any rule will not be returned by these methods. The main differences among the methods above are in the relaxation rules and the scoring functions they use.

The goal of XML keyword search is to find the top K subtrees of a document given a set of keywords. Answers are subtrees that contain at least one such keyword. Because two keywords may appear in different branches of the XML tree (and thus be far from each other in terms of structure), candidate answers are ranked based on a content score (indicating how well a subtree covers the keywords) and a structural score (indicating how concise a subtree is). These are combined into a single ranking. Kaushik et al. study TA-style algorithms to combine content and structural scores. TASM differs from keyword search: instead of keywords, queries are entire trees; instead of using text similarity, subtrees are ranked based on the well-understood tree edit distance.

XFinder ranks the top-k approximate matches of a small query tree in a large document tree. Both the query and the document are transformed to strings using Prüfer sequences, and the tree edit distance is approximated by the longest subsequence distance between the resulting strings. The edit model used to compute distances in XFinder does not handle renaming operations. Also, no runtime analysis is given and the experiments reported use documents of up to 5 MB.

For ordered trees like XML the problem of computing the similarity between the query and the subtrees of the document can be solved with elegant dynamic programming formulations. Zhang and Shasha present an O(n² log²n) time and O(n²) space algorithm for trees with n nodes and height O(logn). Their worst case complexity is O(n⁴). Demaine et al. use a different tree decomposition strategy to improved the time complexity to O(n³) in the worst case. This is not a concern in practice since XML documents tend to be shallow and wide.

Guha et al. match pairs of XML trees from heterogeneous repositories whose tree edit distance falls within a threshold. They give upper and lower bounds for the tree edit distance that can be computed in O(n²) time as a pruning strategy to avoid comparing all pairs of trees from the repositories. Yang et al. and Augsten et al. provide lower bounds for the tree edit distance that can be computed in O(nlogn) time.

Approximate substructure matching has also been studied in the context of graphs. TALE is a tool that supports approximate graph queries against large graph databases. TALE is based on an indexing method that scales linearly to the number of nodes of the graph database. TALE uses heuristic techniques and does not guarantee that the final answer will include the best matches or that all possible matches will be considered.

Based on the above, there is therefore a need for systems and methods that can provide a solution to the TASM issue or which can, at the very least, mitigate the problems with the prior art as noted above.

### SUMMARY OF INVENTION

The present invention provides systems and method for searching for approximate matches in a database of documents represented by a tree structure. A fast solution to the Top-k Approximate Subtree Matching Problem involves determining candidate subtrees which will be considered as possible matches to a query also represented by a tree structure. Once these candidate subtrees are found, a tree edit distance between each candidate subtree and the query tree is calculated. The results are then sorted to find those with the lowest tree edit distance.

In a first aspect, the present invention provides a method for sorting nodes in a document tree to determine a number of closest approximations to a query represented by a query tree, the method comprising:
a) determining a limit size of subtrees of said document tree to be considered;
b) determining candidate subtrees of said document tree, each candidate subtree of said document tree having a size equal to or less than said limit size and each candidate subtree is not a subtree of another subtree having a size less than or equal to said limit size;
c) for each candidate subtree, determining a tree edit distance between said candidate subtree and said query tree;
d) sorting candidate subtrees in accordance with their respective tree edit distances with said query tree, in order to determine which candidate subtrees have least tree edit distances with said query tree;
   wherein said tree edit distance is a cost to convert contents of one subtree into contents of a second subtree.

In a second aspect, the present invention provides computer-readable media having encoded thereon computer readable and computer executable instructions which, when executed, executes a method for sorting nodes in a document tree to determine a number of closest approximations to a query represented by a query tree, the method comprising:
a) determining a limit size of subtrees of said document tree to be considered;
b) determining candidate subtrees of said document tree, each candidate subtree of said document tree having a size equal to or less than said limit size and each candidate subtree is not a subtree of another subtree having a size less than or equal to said limit size;
c) for each candidate subtree, determining a tree edit distance between said candidate subtree and said query tree;
d) sorting candidate subtrees in accordance with their respective tree edit distances with said query tree, in order to determine which candidate subtrees have least tree edit distances with said query tree;
   wherein said tree edit distance is a cost to convert contents of one subtree into contents of a second subtree.

In yet another aspect, the present invention provides a method for determining which subtrees in a document tree most closely approximate a given query tree, the method comprising:
a) determining a limit size of subtrees of said document tree to be considered;
b) determining candidate subtrees of said document tree, each candidate subtree of said document tree being, at most, equal in size to said limit size,
c) for each candidate subtree, determining a cost to convert contents of said candidate subtree into contents of said query tree;
d) sorting candidate subtrees in accordance with costs for converting said candidate subtrees into said query tree,
e) determining which candidate subtrees have lowest costs for converting said candidate subtrees into said query tree, candidate subtrees having lowest costs for being converted into said query tree being subtrees which most closely approximate said query tree.

### BRIEF DESCRIPTION OF THE DRAWINGS

The embodiments of the present invention will now be described by reference to the following figures, in which identical reference numerals in different figures indicate identical elements and in which:

FIG. 1 illustrates an example query tree G and a document tree H;

FIG. 2 lists decomposition rules for calculating tree edit distance;

FIGS. 2A-2E show the different algorithms used in the invention;

FIG. 3 illustrates an example of decomposing the document tree H in FIG. 1 into prefixes;

FIG. 4 illustrates a calculation of tree edit distances using the rules in FIG. 2 and the query tree G and document tree H;

FIGS. 5a and 5b illustrates an example document tree D and its corresponding postorder queue;

FIG. 6 shows how incoming nodes are appended to the memory buffer;

FIG. 7 illustrates a ring buffer as it is pruned of subtrees;

FIG. 8 shows the prefix arrays of three prefixes derived from the document tree D in FIG. 5a;

FIG. 9 illustrates an implementation of the prefix ring buffer;

FIGS. 10a, 10b, and 10c illustrate execution times for varying sizes of documents, queries, and k;

FIG. 11 illustrates a graph comparing the execution times for TASM-dynamic⁺ and TASM-dynamic for k=5;

FIG. 12 is a graph illustrating memory usage as a function of document size for k=5;

FIG. 13 is a graph showing relative performance of TASM-postorder as a function of document size for 10=8 and k=5

FIGS. 14a, 14b, and 14c are plots showing a comparison of the number of subtrees that various methods have to calculate to find the top-1 ranking of subtrees for a specifically sized query;

FIG. 15 illustrates cumulative subtree size difference for computing top-1 queries; and

FIG. 16 is a diagram illustrating an example edit mapping between two trees A and B.

### DETAILED DESCRIPTION OF THE INVENTION

As will be seen below, there is developed an efficient method for TASM based on a prefix ring buffer that performs a single scan of the large document. The size of the prefix ring buffer is independent of the document size. Also provided for below are:
A proof of an upper bound τ on the size of the subtrees that must be considered for solving TASM. This threshold is independent of document size and structure.
An introduction of a prefix ring buffer to prune subtrees larger than τ in O(τ) space, during a single postorder scan of the document.
Also provided is TASM-postorder, an efficient and scalable method for solving TASM. The space complexity is independent of the document size and the time complexity is linear in the document size.

To begin, the problem to be solved must first be defined.

Definition 1 (Top-k Approximate Subtree Matching Problem).

Let Q (query) and T (document) be ordered labeled trees, n be the number of nodes of T, Tᵢ be the subtree of T that is rooted at node tᵢ and includes all its descendants, d(.,.) be a distance function between ordered labeled trees, and k≦n be an integer. A sequence of subtrees, R=(Tᵢ_{₁}, Tᵢ_{₂}, . . . , Tᵢ_{ₖ}), is a top-k ranking of the subtrees of the document T with respect to the query Q iff
1. the ranking contains the k subtrees that are closest to the query:

∀Tⱼ∉R:d(Q,Tᵢ_{ₖ})≦d(Q,Tⱼ), and
2. the subtrees in the ranking are sorted by their distance to the query:

∀1≦k:d(Q,Tᵢ_{ⱼ})≦d(Q,Tᵢ_{ⱼ₊₁}).

Top-k approximate subtree matching (TASM) is the problem of computing a top K ranking of the subtrees of a document T with respect to a query Q.

TASM relates to determining how similar one tree is to another. The tree edit distance has emerged as the standard measure to capture the similarity between ordered labeled trees. Given a cost model, it sums up the cost of the least costly sequence of edit operations that transforms one tree into the other.

A tree T is a directed, acyclic, connected graph with nodes V(T) and edges E(T), where each node has at most one incoming edge. A node, tᵢ∈V(T), is an (identifier, label) pair. The identifier is unique within the tree. The label, λ(tᵢ)∈Σ, is a symbol of a finite alphabet Σ. The empty node ε does not appear in a tree. V_{ε}(T)=V(T)∪{ε} denotes the set of all nodes of T extended with the empty node ε. By |T|=|V(T)| we denote the size of T. An edge is an ordered pair (tₚ, t_{c}), where tₚ, t_{c}∈V(T) are nodes, and tₚ is the parent of t_{c}. Nodes with the same parent are siblings.

The nodes of a tree are strictly and totally ordered. Node t_{c} is the i-th child of tₚ iff tₚ is the parent of t_{c} and i=|{tₓ∈V(T):(tₚ, tₓ)∈E(T), tₓ≦t_{c}})|. Any child node t_{c} precedes its parent node tₚ in the node order, written t_{c}<tₚ. The tree traversal that visits all nodes in ascending order is the postorder traversal.

The number of tₚ's children is its fanout fₜ_{ₚ}. The node with no parent is the root node, treeroot(T), and a node without children is a leaf. An ancestor of tᵢ is a node tₐ in the path from the root node to tᵢ, tₐ≠tᵢ. With anc(t_{d}) we denote the set of all ancestors of a node t_{d}. Node t_{d} is a descendant of tᵢ iff tᵢ∈anc(t_{d}). A node tᵢ is to the left of a node tⱼ iff tᵢ<tⱼ and tᵢ is not a descendant of tⱼ.

Tᵢ is the subtree rooted in node tᵢ of T iff V(Tᵢ)={tₓ|tₓ=tᵢ or tₓ is a descendant of tᵢ in T} and E(Tᵢ)⊂E(T) is the projection of E(T) w.r.t. V(Tᵢ), thus retaining the original node ordering. By lml(tᵢ) we denote the leftmost leaf of Tᵢ, i.e., the smallest descendant of node tᵢ. A subforest of a tree T is a graph with nodes

V′⊂V(T)

and edges E′={(tᵢ, tⱼ)|(tᵢ, tⱼ)∈E(T), tᵢ∈V′, tⱼ∈V′}

A postorder queue is a sequence of (label, size) pairs of the tree nodes in postorder, where label is the node label and size is the size of the subtree rooted in the respective node. A postorder queue uniquely defines an ordered labeled tree. The only operation allowed on a postorder queue is dequeue, which removes and returns the first element of the sequence.

Definition 2 (Postorder Queue)

Given a tree T with n=|T| nodes, the postorder queue, post(T), of T is a sequence of pairs ((l₁, s₁), (l₂, s₂), . . . , (lₙ, sₙ)), where lᵢ=λ(tᵢ), sᵢ=|Tᵢ|, with tᵢ being the i-th node of T in postorder. The dequeue operation on a postorder queue p=(p₁, p₂, . . . , pₙ) is defined as

dequeue (p)=((p₂, p₃, . . . , pₙ), p₁)

An edit operation transforms a tree Q into a tree T. We use the standard edit operations on trees: delete a node and connect its children to its parent maintaining the sibling order; insert a new node between an existing node, tₚ, and a subsequence of consecutive children of tₚ; and rename the label of a node. We define the edit operations in terms of edit mappings.

Definition 3 (Edit Mapping and Node Alignment).

Let Q and T be ordered labeled trees. M⊂V_{ε}(Q)timesV_{ε}(T) is an edit mapping between Q and T iff
1. every node is mapped:
   (a) ∀qᵢ(qᵢ∈V(Q) [symbol] ∃tⱼ((qᵢ, tⱼ)∈M))
   (b) ∀tᵢ(tᵢ∈V(T) [symbol] ∃qⱼ((qⱼ, tᵢ)∈M))
   (c) (ε, ε)∈M
2. all pairs of non-empty nodes (qᵢ, tⱼ), (qₖ, tᵢ)∈M satisfy the following conditions:
   (a) qᵢ=qₖ [symbol] tⱼ=tᵢ (one-to-one condition)
   (b) qᵢ is an ancestor of qₖ [symbol] tⱼ is an ancestor of tᵢ (ancestor condition)
   (c) qᵢ is to the left of qₖ [symbol] tⱼ is to the left of tᵢ (order condition)
      A pair (qᵢ, tⱼ)∈M is a node alignment.

Non-empty nodes that are mapped to other non-empty nodes are either renamed or not modified when Q is transformed into T. Nodes of Q that are mapped to the empty node are deleted from Q, and nodes of T that are mapped to the empty node are inserted into T.

In order to determine the distance between trees a cost model must be defined. We assign a cost to each node alignment of an edit mapping. This cost is proportional to the costs of the nodes.

Definition 4 (Cost of Node Alignment)

Let Q and T be ordered labeled trees, let cst(x)≧1 be a cost assigned to a node x, qᵢ∈V_{ε}(Q), tⱼ∈V_{ε}(T). The cost of a node alignment γ(qᵢ, tⱼ), is defined as:

$$γ ( {q}_{i} , {t}_{j} ) = \{ \begin{matrix}cst ( {q}_{i} ) & if {q}_{i} \neq ∈ Λ {t}_{j} = ∈ & ( delete ) \\ cst ( {t}_{j} ) & if {q}_{i} = ∈ Λ {t}_{j} \neq ∈ & ( insert ) \\ ( cst ( {q}_{i} ) + cst ( {t}_{j} ) ) \text{/} 2 & & ( rename ) \\ & if {q}_{i} \neq ∈ Λ {t}_{j} \neq ∈ Λ λ ( {q}_{i} ) \neq λ ( {t}_{j} ) & \\ 0 & & ( no change ) \\ & if {q}_{i} \neq ∈ Λ {t}_{j} \neq ∈ Λ λ ( {q}_{i} ) = λ ( {t}_{j} ) & \end{matrix}$$

Definition 5 (Cost of Edit Mapping)

Let Q and T be two ordered labeled trees, M⊂V_{ε}(Q)timesV_{ε}(T) be an edit mapping between Q and T, and γ(qᵢ, tⱼ) be the cost of a node alignment. The cost of the edit mapping M is defined as the sum of the costs of all node alignments in the mapping:

$${γ}^{*} ( M ) = {\sum }_{( {q}_{i} , {t}_{j} ) ∈ M} γ ( {q}_{i} , {t}_{j} )$$

The tree edit distance between two trees Q and T is the cost of the least costly edit mapping.

Definition 6 (Tree Edit Distance)

Let Q and T be two ordered labeled trees. The tree edit distance, δ(Q, T), between Q and T is the cost of the least costly edit mapping, M⊂V_{ε}(Q)timesV_{ε}(T), between the two trees:

δ(Q,T)=min{γ*(M)|M⊂V_{∈}(Q)×V_{∈}(T) is an edit mapping}

In the unit cost model all nodes have cost 1, and the unit cost tree edit distance is the minimum number of edit operations that transforms one tree into the other. Other cost models can be used to tune the tree edit distance to specific application needs, for example, the fanout weighted tree edit distance makes edit operations that change the structure (insertions and deletions of non-leaf nodes) more expensive; in XML, the node cost can depend on the element type.

### Example 1

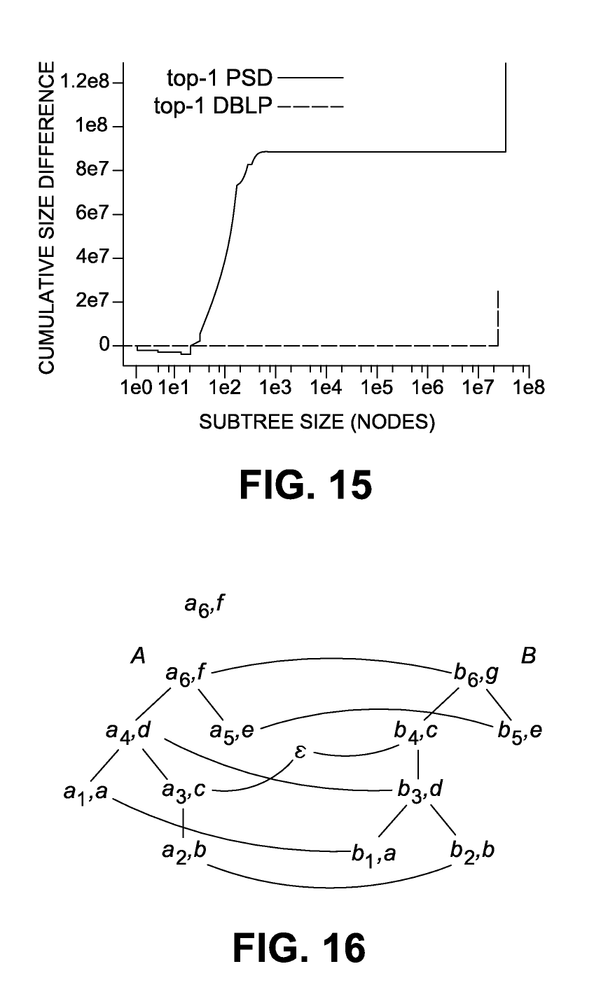

FIG. 16 illustrates an edit mapping M=((a₁, b₁), (a₂, b₂), (a₃, Q), (a₄, b₃), (Q, b₄), (a₅, b₅), (a₆, b₆)) between trees A and B. If the cost of all nodes of A and B is 1, γ(a₆, b₆)=γ(a₃, Q)=γ(Q, b₄)=1; the cost of all other node alignments is zero. M is the least costly edit mapping between A and B, thus the tree edit distance is δ(A, B)=γ*(M)=3 (node a₆ is renamed, a₃ is deleted, b₄ is inserted).

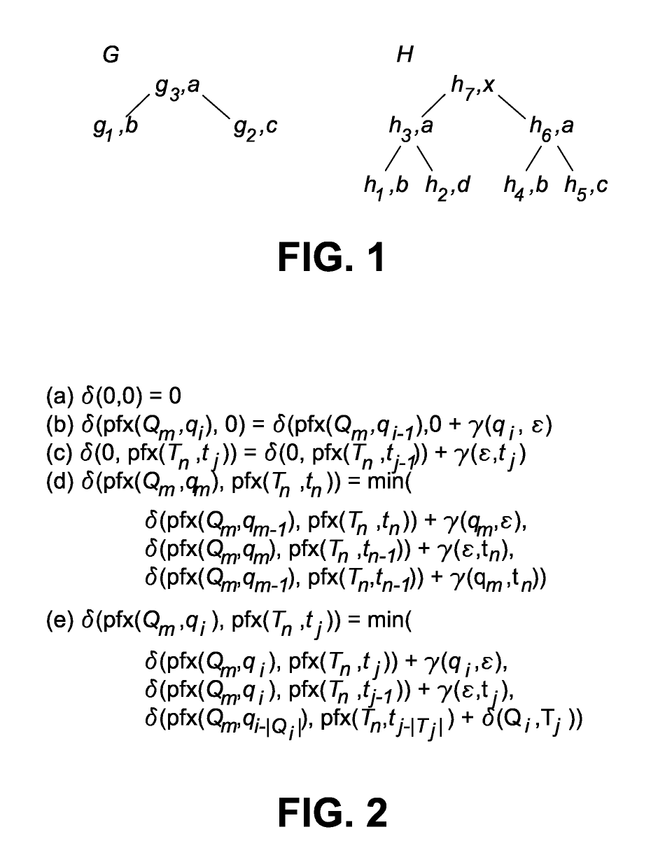

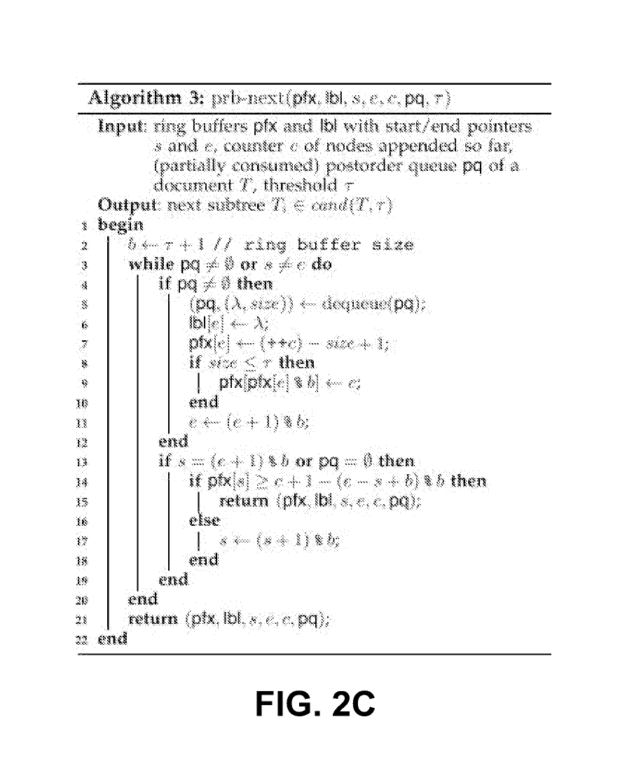

The fastest algorithms for the tree edit distance use dynamic programming. This section discusses the classic algorithm by Zhang and Shasha which recursively decomposes the input trees into smaller units and computes the tree distance bottom-up. The decompositions do not always result in trees, but may also produce forests; in fact, the decomposition rules of Zhang and Shasha assume forests. A forest is recursively decomposed by deleting the root node of the rightmost tree in the forest, deleting the rightmost tree of the forest, or keeping only the rightmost tree of the forest. FIG. 3 illustrates the decomposition of the example document H in FIG. 1.

The decomposition of a tree results in the set of all its subtrees and all the prefixes of these subtrees. A prefix is a subforest that consists of the first i nodes of a tree in postorder.

Definition 7 (Prefix)

Let T be an ordered labeled tree, and tᵢ be the i-th node of T in postorder. The prefix pfx(T, tᵢ) of T, 1≦i≦|T|, is a forest with nodes V′={t₁, t₂, . . . , tᵢ} and edges E′={(tₖ, tₗ)|(tₖ, tₗ)∈E(T), tₖ∈V′, tₗ∈V′}

A tree with n nodes has n prefixes. The first line in FIG. 3 shows all prefixes of example document H.

The tree edit distance algorithm computes the distance between all pairs of subtree prefixes of two trees. Some subtrees can be expressed as a prefix of a larger subtree, for example H₃=pfx(H₇, h₃) in FIG. 3. All prefixes of the smaller subtree (e.g., H₃) are also prefixes of the larger subtree (e.g., H₇) and should not be considered twice in the tree edit distance computation. The relevant subtrees are those subtrees that cannot be expressed as prefixes of other subtrees. All prefixes of relevant subtrees must be computed.

Definition 8 (Relevant Subtree)

Let T be an ordered labeled tree and let tᵢ∈V(T). Subtree Tᵢ is relevant iff it is not a prefix of any other subtree: Tᵢ is relevant [symbol] tᵢ∈V(T) [symbol] ∀tₖ, tₗ(tₖ∈V(T), tₖ≠tᵢ, tₗ∈V(Tₖ) [symbol] Tᵢ≠pfx(Tₖ, tₗ)).

### Example 1

Consider the example trees in FIG. 1. The relevant subtrees of G are G₂ and G₃, the relevant subtrees of H are H₂, H₅, H₆, and H₇.

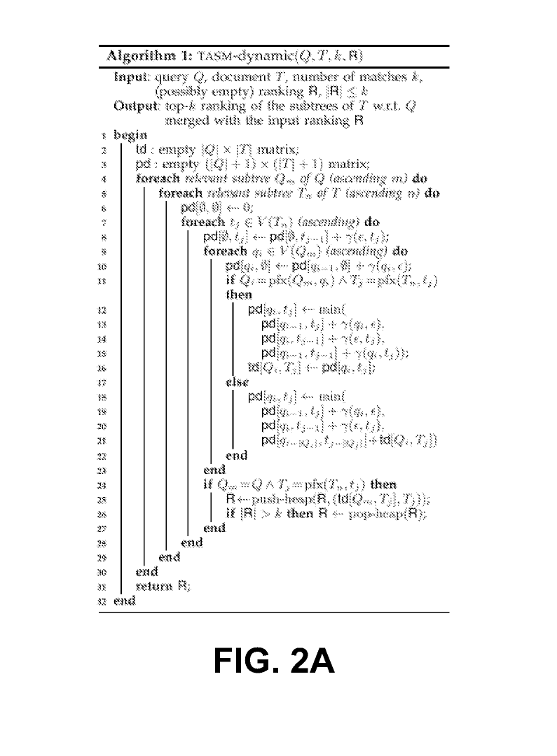

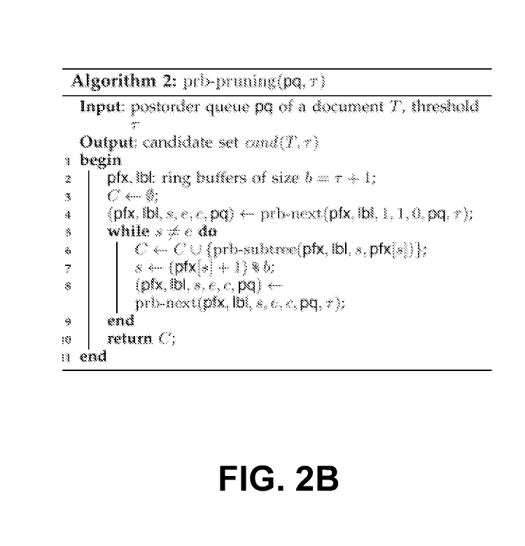

The decomposition rules for the tree edit distance are given in FIG. 2; they decompose the prefixes of two (sub)trees Qₘ and Tₙ (qᵢ≦qₘ, tⱼ≦tₙ). Rule (e) decomposes two general prefixes, (d) decomposes two prefixes that are proper trees (rather than forests), (b) and (c) decompose one prefix when the other prefix is empty, and (a) terminates the recursion.

The dynamic programming method for the tree edit distance fills the tree distance matrix td, and the last row of td stores the distances between the query and all subtrees of the document. This yields a simple solution to TASM: compute the tree edit distance between the query and the document, sort the last row of matrix td, and add the k closest subtrees to the ranking. We refer to this method as TASM-dynamic. (See FIG. 2A)

TASM-dynamic is a dynamic programming implementation of the decomposition rules in FIG. 2. A matrix td stores the distances between all pairs of subtrees of Q and T. For each pair of relevant subtrees, Qₘ and Tₙ, a temporary matrix pd is filled with the distances between all prefixes of Qₘ and Tₙ. The distances between all prefixes that are proper subtrees (rather than forests) are saved in td. Note that the prefix pfx(Qₘ, qᵢ) is a proper subtree iff pfx(Qₘ, qᵢ)=Qᵢ.

The ranking, Heap, is implemented as a max-heap that stores (key, value) pairs: max(Heap) returns the maximum key of the heap in constant time; push-heap(Heap, (k, v)) inserts a new element (k, v) in logarithmic time; and pop-heap(Heap) deletes the element with the maximum key in logarithmic time. Merging two heaps Heap and Heap′ yields a new heap of size x=max(|Heap|, |Heap′|), which contains the x elements of Heap and Heap′ with the smallest keys. Instead of sorting the distances at the end, The method illustrated above updates the ranking whenever a new distance between the query and a subtree of the document is available. The input ranking will be used later and is here assumed to be empty.

### Example 2

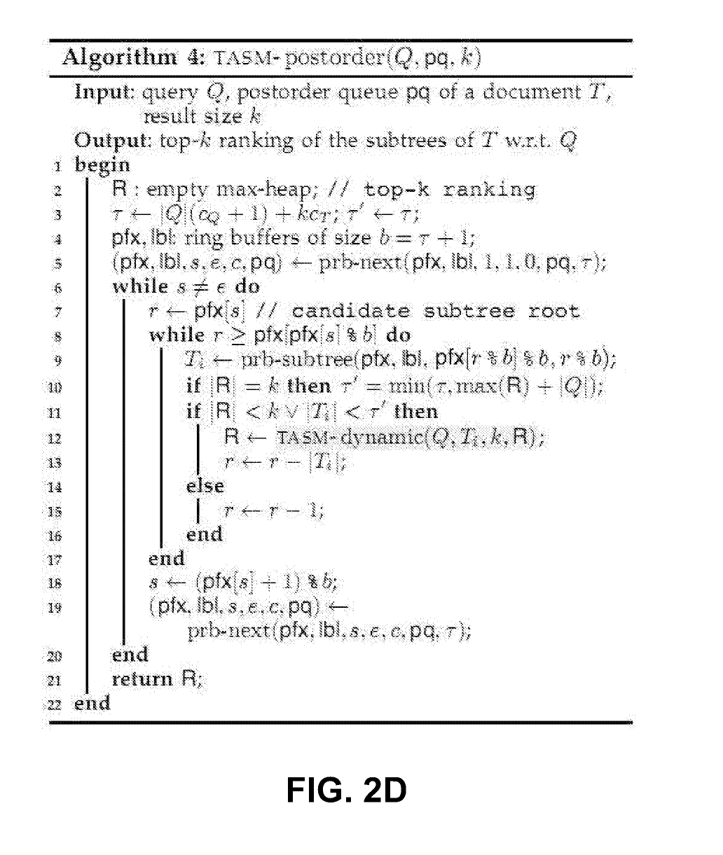

TASM-dynamic is computed for (k=2) for query G and document H in FIG. 1 (the cost for all nodes is 1, the input ranking is empty). FIG. 4 shows the prefix and the tree distance matrixes that are filled by TASM-dynamic. Consider, for example, the prefix distance matrix between G₃ and H₆. The matrix is filled column by column, from left to right. The element pd[g₂][h₅] stores the distance between the prefixes pfx(G₃, g₂) and pfx(H₆, g₅) The upper left element is 0 (Rule (a) in FIG. 2); the first column stores the distances between the prefixes of G₃ and the empty prefix and is computed with Rule (b); similarly, the elements in the first row are computed with Rule (c); the shaded cells are distances between proper subtrees and are computed with formula (d); the remaining cells use formula (e). The shaded values of pd are copied to the tree distance matrix td. The two smallest distances in the last row are 0 (column 6) and (column 3), thus the top-2 ranking is R=(H₆, H₃).

The TASM-dynamic method is one method for solving TASM. It is a fairly efficient approach since it adds a minimal overhead to the already very efficient tree edit distance method. The dynamic programming tree edit distance method uses the result for subtrees to compute larger trees, thus no subtree distance is computed twice. Also, TASM-dynamic improves on the naive solution to TASM by a factor of O(n) in terms of time. However, for each pair of relevant subtrees, Qₘ and Tₙ, a matrix of size O(|Qₘ|Times|Tₙ|) must be computed. As a result, TASM-dynamic requires both the query and the document to be memory resident, leading to a space overhead that is prohibitive even for moderately large documents.

As will be discussed in below, there is an effective bound on the size of the largest subtrees of a document that can be in the top K best matches w.r.t. to a query. The key challenge in achieving an efficient solution to TASM is being able to prune large subtrees efficiently and perform the expensive tree edit distance computation on small subtrees only (for which computing the distance to the query is unavoidable). One piece of a solution to TASM is the prefix ring buffer together with a memory-efficient method for pruning large subtrees.

Definition 9 (Candidate Set):

Given a tree T and an integer threshold τ>0. The candidate set of T for threshold τ is defined as cand(T, τ)={Tᵢ|tᵢ∈V(T), |Tᵢ|≦τ, ∀tₐ∈anc(tᵢ): |Tₐ|>τ}. Each element of the candidate set is a candidate subtree.

### Example 3

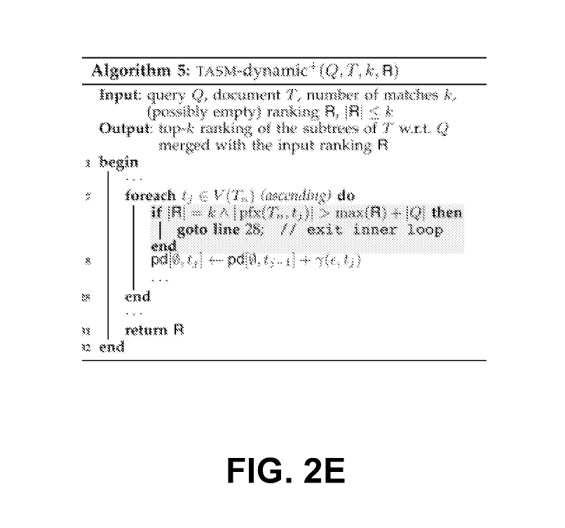

The candidate set of the example document D in FIG. 5a for threshold τ=6 is cand (D, 6)={D₅, D₇, D₁₂, D₁₇, D₂₁}.

It should be noted that the candidate set is not the set of all subtrees smaller than threshold τ, but a subset. If a subtree is contained in a different subtree that is also smaller than τ, then it is not in the candidate set. In the dynamic programming approach the distances for all subtrees of a candidate subtree Tᵢ are computed as a side-effect of computing the distance for the candidate subtree Tᵢ. Thus, subtrees of a candidate subtree need no separate computation.

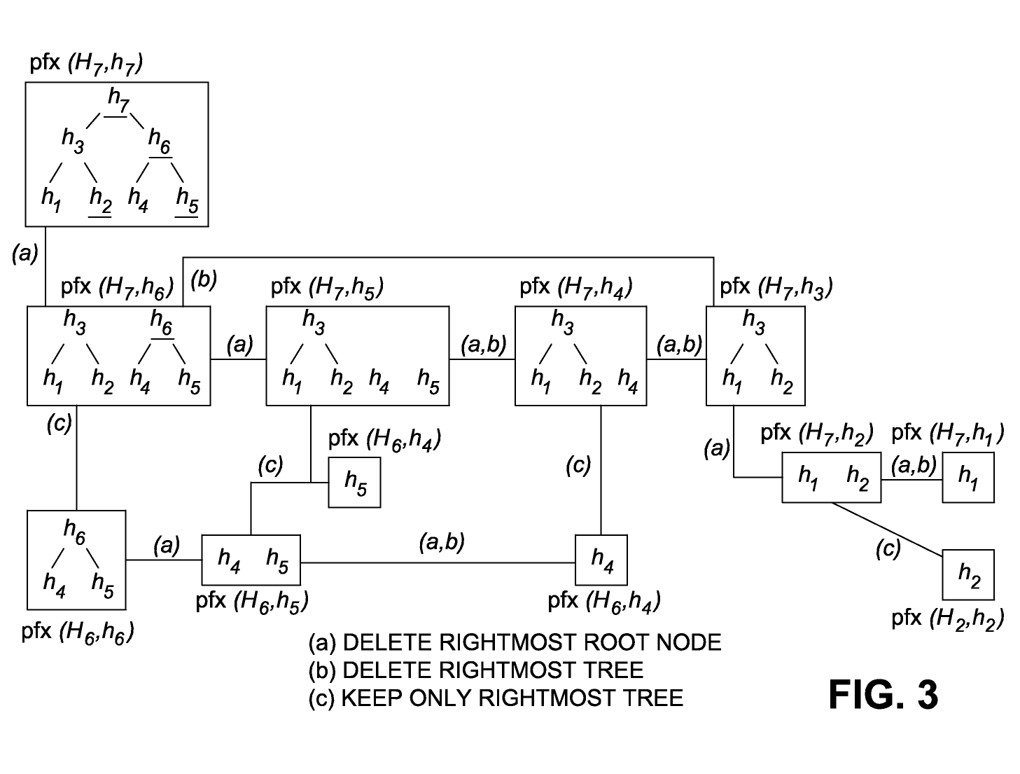

Explained below is how to compute the candidate set given a size threshold τ for a document represented as a postorder queue. Nodes that are dequeued from the postorder queue are appended to a memory buffer (see FIG. 6) where the candidate subtrees are materialized. Once a candidate subtree is found, it is removed from the buffer, and its tree edit distance to the query is computed.

The nodes in the memory buffer form a prefix of the document (see Definition 7) consisting of one or more subtrees. All nodes of a subtree are stored at consecutive positions in the buffer: the leftmost leaf of the subtree is stored in the leftmost position, the root in the rightmost position. Each node that is appended to the buffer increases the prefix. New non-leaf nodes are ancestors of nodes that are already in the buffer. They either grow a subtree in the buffer or connect multiple subtrees already in the buffer into a new, larger, subtree.

### Example 4

The buffer in FIG. 6 stores the prefix pfx (D, d₄) which consists of the subtrees D₂ and D₄. When node d₅ is appended, the buffer stores pfx(D, d₅) which consists of a single subtree, D₅. The subtree D₅ is stored at positions 1 to 5 in the buffer: position 1 stores the leftmost leaf (d₁), position 5 the root (d₅).

The challenge is to keep the memory buffer as small as possible, i.e., to remove nodes from the buffer when they are no longer required. The nodes in the postorder queue are distinguished as candidate and non-candidate nodes: candidate nodes belong to candidate subtrees and must be buffered; non-candidate nodes are root nodes of subtrees that are too large for the candidate set. Non-candidate nodes are easily detected since the subtree size is stored with each node in the postorder queue. Candidate nodes must be buffered until all nodes of the candidate subtree are in the buffer. It is not obvious whether a subtree in the buffer is a candidate subtree, even if it is smaller than the threshold, because other nodes appended later may increase the subtree without exceeding τ.

A simple pruning approach is to append all incoming nodes to the buffer until a non-candidate node t_{c} is found. At this point, all subtrees rooted among t_{c}'s children that are smaller than τ are candidate subtrees. They are returned and removed from the buffer. This approach must wait for the parent of a subtree root before the subtree can be returned. In the worst case, this requires to look O(n) nodes ahead and thus a buffer of size O(n) is required. Unfortunately, the worst case is a frequent scenario in data-centric XML with shallow and wide trees. For example, τ=50 is a reasonable threshold when matching articles in DBLP. However, over 99% of the 1.2M subtrees of the root node of DBLP are smaller than τ; with the simple pruning approach, all of them will be buffered until the root node is processed.

### Example 5

Consider the example document in FIG. 5. We use the simple approach to prune subtrees with threshold τ=6. The incoming nodes are appended to the buffer until a non-candidate arrives. The first non-candidate is d₁₈ (represented by (proceedings, 13)), and all nodes appended up to this point (d₁ to d₁₇) are still in the buffer. The subtrees rooted in d₁₈'s children (d₇, d₁₂, and d₁₇) are in the candidate set. They are returned and removed from the buffer. The subtrees rooted in d₅ and d₂₁ are returned and removed from the buffer when the root node arrives.

The simple pruning is not feasible for large documents. Discussed below is ring buffer pruning which buffers candidate trees only as long as necessary and uses a look-ahead of only O(t) nodes. This is significant since the space complexity no longer depends on the document size.

The size of the ring buffer is b=τ+1. Two pointers are used: the start pointer s points to the first position in the ring buffer, the end pointer e to the position after the last element. The ring buffer is empty iff s=e, and the ring buffer is full iff s=(e+1)%b (% is the modulo operator). The number of elements in the ring buffer is (e−s+b)%b≦b−1. Two operations are defined on the ring buffer: (a) remove the leftmost node or subtree, (b) append node tⱼ. Removing the leftmost subtree Tᵢ means incrementing s by |Tᵢ|. Appending node tⱼ means storing node tⱼ at position e and incrementing e.

### Example 6

The ring buffer (ε, d₁, d₂, d₃, d₄, d₅, d₆), s=1, e=0, is full. Removing the leftmost subtree, D₅, with 5 nodes, gives s=6 and e=0. Appending node d₇ results in (d₇, d₁, d₂, d₃, d₄, d₅, d₆), s=6, e=1.

As the buffer is updated, it is possible that at a given point in time consecutive nodes in the buffer form a subtree that does not exist in the document. For example, nodes (d₁₃, d₁₄, . . . , d₁₈) form a subtree with root node d₁₈ that is different from D₁₈. A subtree in the buffer is valid if it exists in the document. Further below is introduced the prefix array to find the leftmost valid subtree in constant time.

The ring buffer pruning process of a postorder queue of a document T and an empty ring buffer of size τ+1 is as follows:
1. Dequeue nodes from the postorder queue and append them to a ring buffer until the ring buffer is full or the postorder queue is empty.
2. If the leftmost node of the ring buffer is a non-leaf, then remove it from the buffer, otherwise add the leftmost valid subtree to the candidate set and remove it from the buffer.
3. Go to 1) if the postorder queue is not empty; go to) if the postorder queue is empty but the ring buffer is not; otherwise terminate.

A non-leaf tᵢ appears at the leftmost buffer position if all its descendents are removed but tᵢ is not, for example, after removing the subtrees D₇, D₁₂, and D₁₇, the non-leaf d₁₈ of document D is the leftmost node in the buffer.

### Example 7

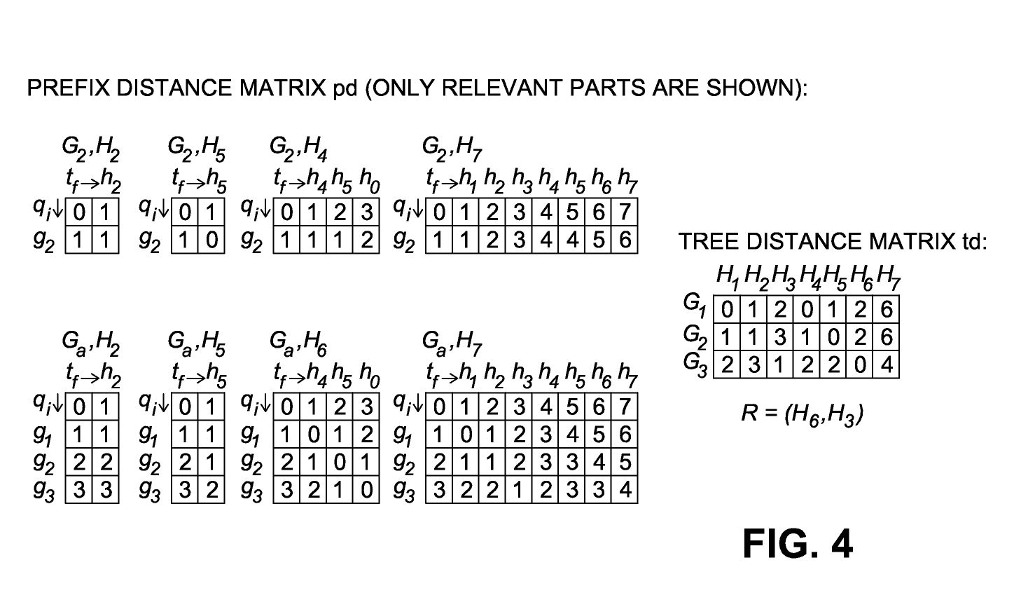

Ring buffer pruning is illustrated on the example tree in FIG. 5. The ring buffer is initialized with s=e=1. In Step 1 nodes d₁ to d₆ are appended to the ring buffer (s=1, e=0, see FIG. 7). The ring buffer is full and we move to Step 2. The leftmost valid subtree, D₅, is returned and removed from the buffer (s=6, e=0). The postorder queue is not empty and the process returns to Step 1 where the ring buffer is filled for the next execution of Step 2. FIG. 7 shows the ring buffer each time before Step 2 is executed. The shaded cells represent the subtree that is returned in Step 2. Note that in the fourth iteration D₁₇ is returned, not the subtree rooted in d₁₈, since the subtree rooted in d₁₈ is not valid. Nodes d₁₈ and d₂₂ are non-candidates and they are not returned. After removing d₂₂ the buffer is empty and the process terminates.

The following relates to a proof for the correctness of ring buffer pruning. The ring buffer pruning classifies subtree Tᵢ as candidate or non-candidate based on the nodes already buffered. Lemma 1 proves that this can be done by checking only the τ−|Tᵢ| nodes that are appended after tᵢ and are ancestors of tᵢ: if all of these nodes are non-candidates, then Tᵢ is a candidate tree. The intuition is that a parent of tᵢ that is appended later is an ancestor of both the nodes of tᵢ and the τ−|Tᵢ| nodes that follow tᵢ; thus the new subtree must be larger than τ.

### Example 8

Consider Example document D of FIG. 5, τ=6. Fᵢ is the set of τ−|Dᵢ| nodes that are appended after dᵢ. The subtree D₂ is not in the candidate set since F₂={d₃, d₄, d₅, d₆} contains d₅, which is an ancestor of d₂ and a candidate node. D₂₁ is a candidate subtree: |D₂₁|≦τ, F₂₁={d₂₂}, d₂₂ is an ancestor of d₂₁ and |D₂₂|>τ. (|F₂₁|<τ−|D₂₁| since F₂₁ contains the root node d₂₂ which is the last node that is appended.)

Lemma 1 Let T be a tree, cand(T, τ) the candidate set of T for threshold τ, tᵢ the i-th node of T in postorder, and Fᵢ={tⱼ|tⱼ∈V(T), i<j≦i−|Tᵢ|+τ} the set of at most τ−|Tᵢ| nodes following tᵢ in postorder. For all 1≦i≦|T|

Tᵢ∈cand(T,τ) [symbol] |Tᵢ|≦τΛ∀tₓ(tₓ∈Fᵢ∩anc(tᵢ) [symbol] |Tₓ|>τ) (1)

Proof 1

If |Tᵢ|>tau, then the left side of (1) is false since Tᵢ is not a candidate tree, and the right side is false due to condition |Tᵢ|≦τ, thus (1) holds. If |Tᵢ|≦τ it can be shown that

(tₓ∈Fᵢ∩anc(tᵢ) [symbol] |Tₓ|>τ) [symbol] (tₓ∈anc(tᵢ) [symbol] |Tₓ|>τ). (2)

which makes (1) equivalent to the definition of the candidate set (cf. Definition 9). Case i+τ−|Tᵢ|≧|T|: Fᵢ contains all nodes after tᵢ in postorder, thus Fᵢ∩anc(tᵢ)=anc(tᵢ) and (2) holds. Case i+τ−|Tᵢ|<|T|: (2) holds for all tₓ∈Fᵢ∩anc(tᵢ). If tₓ∈anc(tᵢ)\Fᵢ, then tₓ∉Fᵢ∩anc(tᵢ) and the left side of (2) is true. Since any tₓ∈anc(tᵢ)\Fᵢ is an ancestor of all nodes of both Tᵢ and Fᵢ, |Tₓ|>|Tᵢ|+|Fᵢ|=τ, and (2) holds.

As illustrated in FIG. 7 the ring buffer pruning removes either candidate subtrees or non-candidate nodes from the buffer. After each remove operation the leftmost node in the buffer is checked. If the leftmost node is a leaf, then it starts a candidate subtree, otherwise it is non-candidate node.

Lemma 2

Let T be an ordered labeled tree, cand(T, τ) be the candidate set of T for threshold τ, tₛ be the next node of T in postorder after a non-candidate node or after the root node of a candidate subtree, or tₛ=tₗ, and lml(t) be the leftmost leaf descendant of the root tᵢ of subtree Tᵢ.

tₛ is a leaf [symbol] ∃Tₛ:Tᵢ∈cand(T,τ),tₛ=lml(tᵢ)

tₛ is a non-leaf [symbol] tₛ∈{tₓ|tₓ∈V(T),|Tₓ|>τ} (3)

Proof 2

Let NC be the non-candidate nodes of T.
(a) tₛ=tₗ: tₗ is a leaf, thus tₗ∉NC and there is a tᵢ∈cand(T, τ) such that tₗ∈V(Tᵢ). There is no node tₖ<tₗ, thus tₗ=lml(tᵢ).
(b) tₛ follows the root node of a candidate subtree Tⱼ: tₛ is either the parent tₖ of the root node of Tⱼ or a leaf descendant tₗ of tₖ. tₖ∈NC by Definition 9. Since tₗ is a leaf, tₗ∉NC and there must be a Tᵢ∈cand(T, τ) such that tₗ∈V(Tᵢ). The equation tₗ=lml(tᵢ) is proven by contradiction: Assume Tᵢ has a leaf tₓ to the left of tₗ. As V(Tⱼ)∩V(Tᵢ)=Ø, tₓ is to the left of tⱼ, and tₐ∈V(Tᵢ), the least common ancestor of tₗ and tₓ, is an ancestor of tₖ. This is not possible since |Tₖ|>τ [symbol] |Tₐ|>τ [symbol] |Tᵢ|>τ.
(c) tₛ follows a non-candidate node, tₓ∈NC: tₛ is either the parent tₖ of tₓ or a leaf node tₗ. tₖ∈NC by Definition 9, and there is a Tᵢ∈cand(T, τ) such that tₗ=lml(tᵢ) (same rationale as above).

Theorem 1 (Correctness of Ring Buffer Pruning)

Given a document T and a threshold τ, the ring buffer pruning adds a subtree Tᵢ of T to the candidate set iff Tᵢ∈cand(T, τ).

Proof 3

It can be shown that (1) each node of T is processed, i.e., either skipped or output as part of a subtree, and (2) the pruning in Step 2 is correct, i.e., non-candidate nodes are skipped and candidate subtrees are returned.
(1) All nodes of T are appended to the ring buffer: Steps 1 and 2 are repeated until the postorder queue is empty. In each cycle nodes are dequeued from the postorder queue and appended to the ring buffer. All nodes of the ring buffer are processed: The nodes are systematically removed from the ring buffer from left to right in Step 2, and Step 2 is repeated until both the postorder queue and the ring buffer are empty.
(2) Let tₛ be the smallest node of the ring buffer. If tₛ is the leftmost leaf of a candidate subtree, then the leftmost valid subtree, Tᵢ, is a candidate subtree: Since the buffer is either full or contains the root node of T when Step 2 is executed, all nodes Fᵢ={tⱼ|tⱼ∈V(T), i<j≦i−|Tᵢ|+τ} are in the buffer. If a node tₖ∈Fᵢ is an ancestor of tᵢ, then |Tₖ|>τ: If tₛ is the smallest leaf of Tₖ, then Tₖ is the leftmost valid subtree which contradicts the assumption; if the smallest leaf of Tₖ is smaller than tₛ, then Tₖ is not a candidate subtree since it contains tₛ which is the leftmost leaf of a candidate subtree; since tₖ is an ancestor of tₛ, the smallest leaf of Tₖ can not be larger than tₛ. With Lemma 1 it follows that Tᵢ is a candidate subtree. As Tᵢ is a candidate subtree, with Lemma 2 the pruning in Step 2 is correct.

With the correctness of the ring buffer pruning proven, a prefix array may now be explained.

Ring buffer pruning removes the leftmost valid subtree from the ring buffer. A subtree is stored as a sequence of nodes that starts with the leftmost leaf and ends with the root node. A node is a (label, size) pair, and in the worst case we need to scan the entire buffer to find the root node of the leftmost valid subtree. To avoid the repeated scanning of the buffer we enhance the ring buffer with a prefix array which encodes tree prefixes (see Definition 7). This allows us to find the leftmost valid subtree in constant time.

Definition 10 (Prefix Array)

Let pfx(T, tₚ) be a prefix of T, and tᵢ∈V(T), 1≦i≦p, be the i-th node of T in postorder. The prefix array for pfx(T, tₚ) is an integer array (a₁, a₂, . . . , aₚ) where aᵢ is the smallest descendant of tᵢ if tᵢ is a non-leaf node, otherwise the largest ancestor of tᵢ in pfx(T, tₚ) for which tᵢ is the smallest descendant:

$${a}_{i} = \{ \begin{matrix}max \{ x \vert x ∈ pfx ( T , {t}_{p} ) , lml ( x ) = {t}_{i} \} & if {t}_{i} is a leaf \\ lml ( {t}_{i} ) & otherwise\end{matrix}$$

A new node tₚ₊₁ is appended to the prefix array (a₁, a₂, . . . , aₚ) by appending the integer aₚ₊₁=lml(tₚ₊₁) and updating the ancestor pointer of its smallest descendant, a₍ₐ_{ₚ₊₁}₎=aₚ₊₁. A node tᵢ is a leaf iff aᵢ≧i. The largest valid subtree in the prefix with a given leftmost leaf tᵢ is (aᵢ, aᵢ₊₁, . . . , a₍ₐ_{ᵢ}₎) and can be found in constant time.

### Example 9

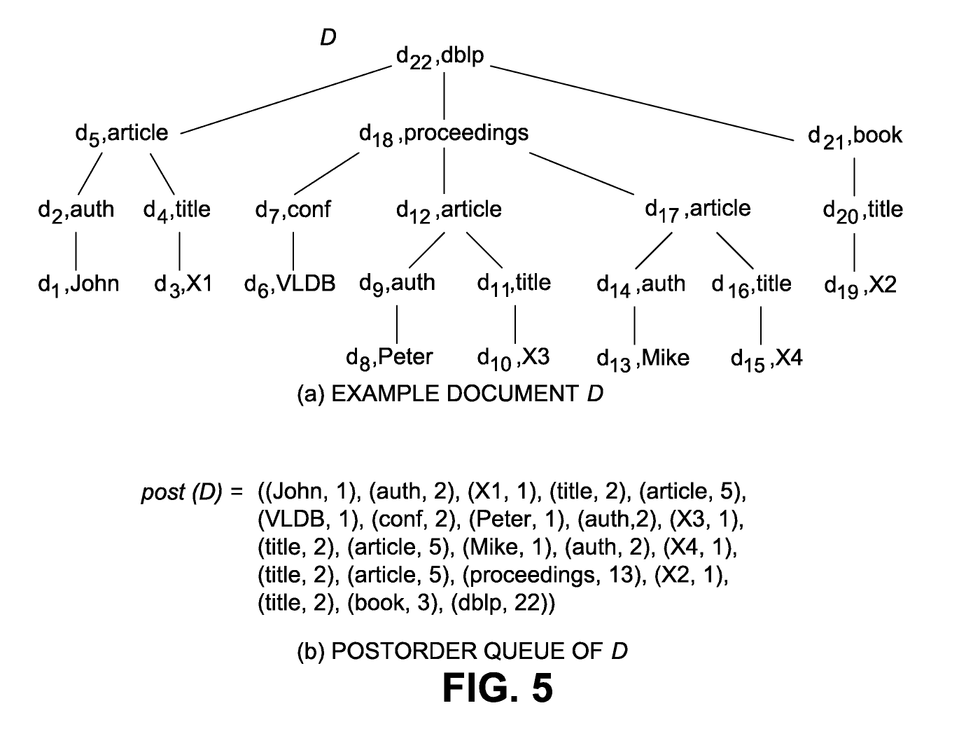

FIG. 8 shows the prefix arrays of different prefixes of the example tree D and illustrates the structure of the prefix arrays with arrows. The prefix array for pfx(D, d₄) is (2, 1, 4, 3). We append d₅ and get (5, 1, 4, 3, 1) (the smallest descendant of d₅ is d₁, thus a₅=1 is appended and a₁ is updated to 5). Appending d₆ gives (5, 1, 4, 3, 1, 6). The largest valid subtree in the prefix pfx(D, d₆) with the leftmost leaf d₁ is (5, 1, 4, 3, 1) (i=1, aᵢ=5).

The pruning removes nodes from the left of the prefix ring buffer such that the prefix ring buffer stores only part of the prefix. The pointer from a leaf to the largest valid subtree in the prefix always points to the right and is not affected. This pointer changes only when new nodes are appended.

Theorem 2

The prefix ring buffer pruning for a document with n nodes and with threshold τ runs in O(n) time and O(τ) space.

Proof 4 Runtime:

Each of the n nodes is processed exactly once in Step 1 and in Step 2, then the algorithm terminates. Dequeuing a node from the postorder queue and appending it to the prefix ring buffer in Step 1 is done in constant time. Removing a node (either as non-candidate or as part of a subtree) in Step 2 is done in constant time. Space: The size of the prefix ring buffer is O(τ). No other data structure is used.

Algorithm 2 (prb-pruning) implements the ring buffer pruning and computes the candidate set cand(T, τ) given the size threshold τ and the postorder queue, pq, of document T. The prefix ring buffer is realized with two ring buffers of size b=τ+1: rbl stores the node labels and rbs encodes the structure as a prefix array. The ring buffers are used synchronously and share the same start and end pointers (s, e). Counter c counts the nodes that have been appended to the prefix ring buffer. (See FIG. 2B)

After each call of prb-next (Algorithm 3) a candidate subtree is ready at the start position of the prefix ring buffer. It is added to the candidate set and removed from the buffer (Lines 6 and 7). prb-subtree(rbs, rbl, a, b) returns the subtree formed by nodes a to b in the prefix ring buffer. Algorithm 3 is called until the ring buffers are empty.

Algorithm 3 loops until both the postorder queue and the prefix ring buffer are empty. If there are still nodes in the postorder queue (Line 3), they are dequeued and appended to the prefix ring buffer, and the ancestor pointer in the prefix array is updated (Line 9). If the prefix ring buffer is full or the postorder queue is empty (Line 13), then nodes are removed from the prefix ring buffer. If the leftmost node is a leaf (Line 14, c+1−(e−s+b)%b is the postorder identifier of the leftmost node), a candidate subtree is returned, otherwise a non-candidate is skipped. (See FIG. 2C)

### Example 10

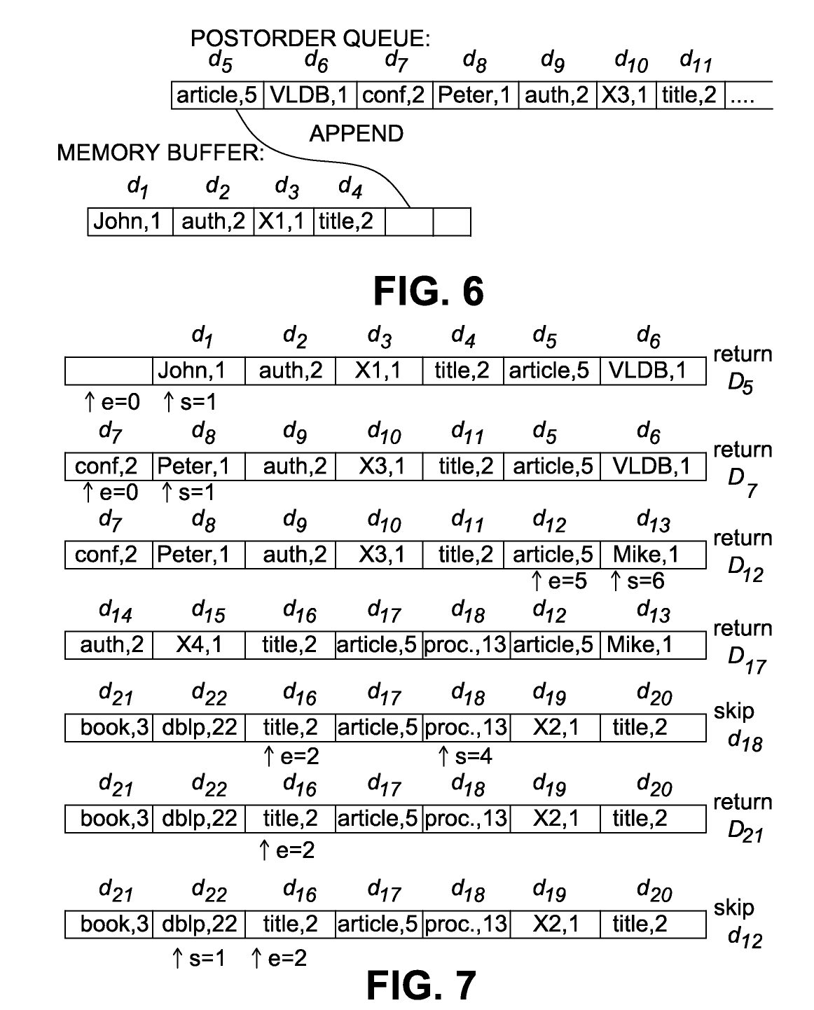

FIG. 9 illustrates the prefix ring buffer for the example document D in FIG. 5. The relative positions in the ring buffer are shown at the top. The small numbers are the postorder identifiers of the nodes. The ring buffers are filled from left to right; overwritten values are shown in the next row.

Now presented is a solution for TASM whose space complexity is independent of the document size and, thus, scales well to XML documents that do not fit into memory. Unlike TASM-dynamic explained above, which requires the whole document in memory, this solution uses the prefix ring buffer and keeps only candidate subtrees in memory at any point in time. The explanation for this solution starts by showing an effective threshold τ for the size of the largest candidate subtree in the document.

Recall that solving TASM consists of finding a ranking of the subtrees of the document according to their tree edit distance to a query. We distinguish intermediate and final rankings. An intermediate ranking, R′=(T_{i′}_{₁}, T_{i′}_{₂}, . . . , T_{i′}_{ₖ}), is the top-k ranking of a subset of at least k subtrees of a document T with respect to a query Q, the final ranking, R=(Tᵢ_{₁}, Tᵢ_{₂}, . . . , Tᵢ_{ₖ}), is the top-k ranking of all subtrees of document T with respect to the query.

It can be shown that any intermediate ranking provides an upper bound for the maximum subtree size that must be considered (Lemma 4). The tightness of such a bound improves with the quality of the ranking, i.e., with the distance between the query and the lowest ranked subtree. We initialize the intermediate ranking with the first k subtrees of the document in postorder. Lemma 5 provides bounds for the size of these subtrees and their distance to the query. The ranking of the first k subtrees provides the upper bound τ=|Q|(c_{Q}+1)+kc_{T}, for the maximum subtree size that must be considered (Theorem 3), where c_{Q} and c_{T} denote the maximum costs of any node in Q and the first k nodes in T, respectively. Note that this upper bound τ is independent of size and structure of the document.

Lemma 3

Let Q and T be ordered labeled trees, then |T|≦δ(Q, T)+|Q|.

Proof 5

It can be shown that |T|−|Q|≦δ(Q, T). True for |T|≦|Q| since δ(Q, T)≧0. Case |T|>|Q|: At least |T|−|Q| nodes must be inserted to transform Q into T. The cost of inserting a new node, tₓ, into T is γ(ε, tₓ)=cst(tₓ)≧1

Lemma 4 (Upper Bound)

Let R′=(T_{i′}_{₁}, T_{i′}_{₂}, . . . , T_{i′}_{ₖ}) be any intermediate ranking of at least k subtrees of a document T with respect to a query Q, and let R be the final top-k ranking of all subtrees of T, then ∀Tᵢ_{ⱼ}(Tᵢ_{ⱼ}∈R [symbol] |Tᵢ_{ⱼ}|≦δ(Q, T_{i′}_{ₖ})+|Q|).

Proof 6

|Tᵢ_{ⱼ}|≦δ(Q, Tᵢ_{ⱼ})+|Q| follows from Lemma 3. We show ∀Tᵢ_{ⱼ}(|Tᵢ_{ⱼ}|∈R [symbol] δ(Q, Tᵢ_{ⱼ})≦δ(Q, t′ᵢ_{ₖ})) by contradiction: Assume a subtree Tᵢ_{ⱼ}∈R, δ(Q, Tᵢ_{ⱼ})>δ(Q, T_{i′}_{ₖ}). Then by Definition 1 also I_{i′}_{ₖ}∈R; if T_{i′}_{ₖ}∈R, then also all other T_{i′}_{ₗ}∈R′ are in R, i.e., R′⊂R. Tᵢ_{ⱼ}∉R′ (since δ(Q, Tᵢ_{ⱼ})>δ(Q, T_{i′}_{ₖ})) but Tᵢ_{ⱼ}∈R, thus R′∩{Tᵢ_{ⱼ}}⊂R. This contradicts |R|=k.

Lemma 5 (First Ranking)

Let Q and T be ordered labeled trees, k≦|T|, c_{Q} and c_{T} be the maximum costs of a node in Q and the first k nodes in T, respectively, tᵢ be the i-th node of T in postorder, then for all Tᵢ, 1≦i≦k, the following holds: |Tᵢ|≦k [symbol] δ(Q, Tᵢ)≦|Q|c_{Q}+kc_{T}.

Proof 7

Let qᵢ be the i-th node of Q in postorder, and lml(tᵢ) the leftmost leaf of Tᵢ. The nodes of a subtree have consecutive postorder numbers. The smallest node is the leftmost leaf, the largest node is the root. Since the leftmost leaf of Tᵢ, 1≦i≦k, is larger or equal 1 and the root is at most k, the subtree size is bound by k. The distance between the query and the document is maximum if the edit mapping is empty, i.e., all nodes of Q are deleted and all nodes of Tᵢ are inserted:

$$δ ( Q , {T}_{i} ) ≦ {\sum }_{{q}_{i} ∈ V ( Q )} γ ( {q}_{i} , ɛ ) + {\sum }_{{t}_{i} ∈ V ( {T}_{i} )} γ ( ɛ , {t}_{i} ) ≦ \vert Q \vert {c}_{Q} + {kc}_{T}$$

since γ(qᵢ, ε)≦c_{Q}, γ(ε, tᵢ)≦c_{T}, and |Tᵢ|≦k.

The three lemmas above are the elements for the main result in this section:

Theorem 3 (Maximum Subtree Size)

Let query Q and document T be ordered labeled trees, c_{Q} and c_{T} be the maximum costs of a node in Q and the first k nodes in T, respectively, R=(Tᵢ_{₁}, Tᵢ_{₂}, . . . , Tᵢ_{ₖ}) be the final top-k ranking of all subtrees of T with respect to Q, then the size of all subtrees in R is bound by τ=|Q|(c_{Q}+1)+kc_{T}:

∀Tᵢ_{ⱼ}(Tᵢ_{ⱼ}∈R [symbol] |Tᵢ_{ⱼ}|≦|Q|(c_{Q}+1)+kc_{T}) (4)

Proof 8

|T|<k: (4) holds since |Tᵢ_{ⱼ}|≦|T|<k≦|Q|(c_{Q}+1)+kc_{T}. |T|≧k: According to Lemma 5 there is an intermediate ranking R′=(T_{i′}_{₁}, T_{i′}_{₂}, . . . , T_{i′}_{ₖ}) with δ(Q, T_{i′}_{ₖ})≦|Q|c_{Q}+kc_{T}, thus δ(Q, Tᵢ_{ⱼ})≦|Q|c_{Q}+kc_{T} (Lemma 4) and |Tᵢ_{ⱼ}|≦|Q|c_{Q}+kc_{T}+|Q| (Lemma 3) for all subtrees Tᵢ_{ⱼ}∈R.

TASM-postorder (Algorithm 4) uses the upper bound τ (see Theorem 3) to limit the size of the subtrees that must be considered, and the set of candidate subtrees, cand(T, τ), is computed using the prefix ring buffer proposed above. When a candidate subtree Tᵢ∈cand(T, τ) is available in the prefix ring buffer (Lines 5 and 19), it is processed and removed (Line 18). If an intermediate ranking is available (i.e., |Heap|=k) the upper bound τ′ provided by the intermediate ranking (see Lemma 4) may be tighter than τ. Only subtrees of Tᵢ that are smaller than τ′ must be considered. The subtrees of Tᵢ (including Tᵢ itself) are traversed in reverse postorder, i.e., in descending order of the postorder numbers of their root nodes. If a subtree of Tᵢ is below the size threshold τ′, then TASM-dynamic is called for this subtree and the ranking Heap is updated. All subtrees of the processed subtree are skipped (Line 13), and the remaining subtrees of Tᵢ are traversed in reverse postorder. (See FIG. 2D)

Theorem 4 (Correctness)

Given a query Q, a document T, and k≦|T|, TASM-postorder (Algorithm 4) computes the top-k ranking R of all subtrees of T with respect to Q.

Proof 9

If no intermediate ranking is available, all subtrees within size τ=|Q|(c_{Q}+1)+kc_{T} are considered. The correctness of τ follows from Theorem 3. Subtrees of size τ′=min(τ, max(Heap)+|Q|) and larger are pruned only if an intermediate ranking with k subtrees is available. Then the correctness of τ′ follows from Lemma 4.

Theorem 5 (Complexity)

Let Q and T be ordered labelled trees, m=|Q|, n=|T|, k≦|T|, c_{Q} and c_{T} be the maximum costs of a node in Q and the first k nodes in T, respectively. Algorithm 4 uses O(m²n) time and O(m²c_{Q}+mkc_{T}) space.

Proof 10

The space complexity of Algorithm 4 is dominated by the call of TASM-dynamic (Q, Tᵢ, k, Heap) in Line 12, which requires O(m|Tᵢ|) space. Since |Tᵢ|≦τ=m(c_{Q}+1)+kc_{T}, the overall space complexity is O(m²c_{Q}+mkc_{T}). The runtime of tasmDynamic(Q, Tᵢ, k, Heap) is O(m²|Tᵢ|). τ is the size of the maximum subtree that must be computed. There can be at most n/τ subtrees of size τ in the document and the runtime complexity is

$$O ( \frac{n}{γ} {m}^{2} τ ) = O ( {m}^{2} n ) .$$

The space complexity is independent of the document size. c_{Q} and C_{T} are typically small constants, for example, c_{Q}=c_{T}=1 for the unit cost tree edit distance, and the document is often much larger than the query. For example, a typical query for an article in DBLP has 15 nodes, while the document has 26M nodes. If we look for the top 20 articles that match the query using the unit cost edit distance, TASM-postorder only needs to consider subtrees up to a size of τ=2|Q|+k=50 nodes, compared to 26M in TASM-dynamic. Note that for TASM-postorder a subtree with 50 nodes is the worst case, whereas TASM-dynamic always computes the distance between the query and the whole document with 26M nodes.

TASM-postorder calls TASM-dynamic for document subtrees that cannot be pruned. TASM-dynamic computes the distances between the query and all subtrees. In this section we apply our pruning rules inside TASM-dynamic and stop the execution early, i.e., before all matrixes are filled. We leverage the fact that the ranking improves during the execution of TASM-dynamic, giving rise to a tighter upper bound for the maximum subtree size.

We refer to TASM-dynamic with pruning as TASM-dynamic⁺ (Algorithm 5). The pruning is inserted between Lines 7 and 8 of TASM-dynamic, all other parts remain unchanged. Whenever the pruning condition holds, the unprocessed columns of the current prefix distance matrix (pd) are skipped. (See FIG. 2E)

### Example 11

We compute TASM-dynamic⁺ (k=2) for the query G and the document H in FIG. 1 (the cost for all nodes is 1, the input ranking is empty). The gray values in the prefix and tree distance matrixes in FIG. 4 are the values that TASM-dynamic⁺ does not need to compute due to the pruning. Before column h₅ in the prefix distance matrix between G₃ and H₇ is computed, Heap=((H₆, 0), (H₃, 1)) and the pruning condition holds (|Heap|=2, |pfx(H₇, h₅)|=5, max(Heap)=1, |G|=3). The columns h₅, h₆, and h₇ can be skipped and the distances δ(G₁, H₇) and δ(G₃, H₇) need not be computed.

Theorem 6 (Correctness of TASM-Dynamic⁺)

Given a query Q, a document T, k≦|T|, and a ranking R of at most k subtrees with respect to the query Q, TASM-dynamic⁺ (Algorithm 5) computes the top-k ranking of the subtrees in the ranking R and all subtrees of document T with respect to the query Q.

Proof 11

Without pruning, the algorithm computes all distances between the query Q and the subtrees of document T. Whenever a new distance is available, the ranking is updated and the final ranking R is correct. If the pruning condition holds for a prefix pfx(Tₙ, tⱼ) of the relevant subtree Tₙ, then column tⱼ of the prefix distance matrix pd, all following columns of pd, and some values of the tree distance matrix td will not be computed. It needs to be shown that (1) a subtree that should be in the final ranking R is not missed, and (2) the values of td that are not computed are not needed later.
(1) Let pᵢ=pfx(Tₙ, tᵢ) be a prefix of Tₙ. We need to show ∀pᵢ(tᵢ≧tⱼ [symbol] pᵢ∉R): If pᵢ is not a subtree then pᵢ∉R (Definition 1). If pᵢ is a subtree, pᵢ∉R follows from Lemma 4: Since the pruning condition requires |Heap|=k, an intermediate ranking (T_{i′}_{₁}, T_{i′}_{₂}, . . . , T_{i′}_{ₖ}) is available and δ(Q, T_{i′}_{ₖ})=max(Heap); thus a subtree Tᵢ can not be in the final ranking if |Tᵢ|>max(Heap)+|Q|. |pfx(Tₙ, tⱼ)|>max(Heap)+|Q| (pruning condition) and pᵢ≧|pfx(Tₙ, tⱼ)| for tᵢ≧tⱼ, thus pᵢ∉R.
(2) Let pd be the prefix distance matrix between two relevant subtrees Qₘ and Tₙ. A column tⱼ of pd can be computed if (a) all columns of pd to the left of tⱼ are filled, and (b) all prefix distance matrixes between Tₙ and the relevant subtrees Qᵢ of Qₘ (Qᵢ≠Qₘ) are filled up to column tⱼ (follows from the decomposition rules in FIG. 2). (a) holds since the columns are computed from left to right, and columns to the right of a pruned column are pruned as well; (b) holds since the prefix distance matrixes for the subtrees Qᵢ are computed before pd, and if the pruning condition holds for column tⱼ in the matrix of a subtree Qᵢ, then it also holds for column tⱼ in the matrix of Qₘ (in the pruning condition, |pfx(Tₙ, tⱼ)| and |Q| do not change and max(Heap) cannot increase).

We adapt TASM-postorder (Algorithm 4) by replacing TASM-dynamic with TASM-dynamic⁺ in Line 12 and use this version of the algorithm in the experimental evaluation below.

Provided below is an experimental evaluation of the solution. The scalability of TASM-postorder is studied using realistic synthetic XML datasets of varying sizes and the effectiveness of the prefix ring buffer pruning on large real world datasets. All algorithms were implemented as single-thread applications in Java 1.6 and run on a dual-core AMD64 server. A standard XML parser was used to implement the postorder queues (i.e., parse and load documents and queries). In all algorithms a dictionary was used to assign unique integer identifiers to node labels (element/attribute tags as well as text content). The integer identifiers provide compression and faster node-to-node comparisons, resulting in overall better scalability.

The scalability of TASM-postorder is studied using synthetic data from the standard XMark benchmark, whose documents combine complex structures and realistic text. There is a linear relation between the size of the XMark documents (in MB) and the number of nodes in the respective XML trees; the height does not vary with the size and is 13 for all documents. We used documents ranging from 112 MB and 3.4M nodes to 1792 MB and 55M nodes. The queries are randomly chosen subtrees from one of the XMark documents with sizes varying from 4 to 64 nodes. For each query size four trees were used. A comparison is made of TASM-postorder against the state-of-the-art solution, TASM-dynamic, implemented using the tree edit distance algorithm by Zhang and Shasha.

Execution Time:

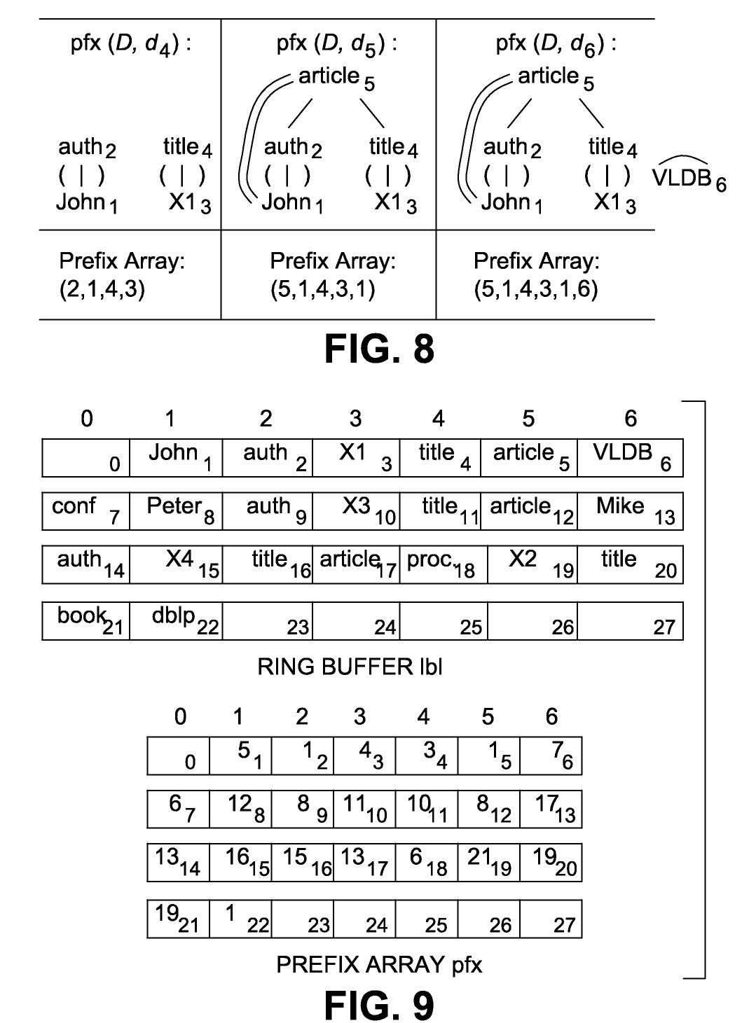

FIG. 10a shows the execution time as a function of the document size for different query sizes |Q| and fixed k=5. Similarly, FIG. 10b shows the execution time versus query size (from 4 to 64 nodes) for different document sizes |T| and fixed k=5. The graphs show averages over 20 runs. The data points missing in the graphs correspond to settings in which TASM-dynamic runs out of main memory (4 GB). As predicted above, the runtime of TASM-postorder is linear in the document size. TASM-postorder scales very well with both the document and the query size, and can handle very large documents or queries. In contrast, TASM-dynamic runs out of memory for trees larger than 500 MB, except for very small queries. Besides scaling to much larger problems, TASM-postorder is also around four times faster than TASM-dynamic.

FIG. 10c shows the impact of parameter k on the execution time of TASM-postorder (|Q|=16). As expected, TASM-dynamic is insensitive to k since it always must compute all subtrees. TASM-postorder, on the other hand, prunes large subtrees, and the size of the pruned subtrees depends on k. As the graph shows (observe the log-scale on the x-axis), TASM-postorder scales extremely well with k: an increase of 4 orders of magnitude in k results only in doubling the low runtime.

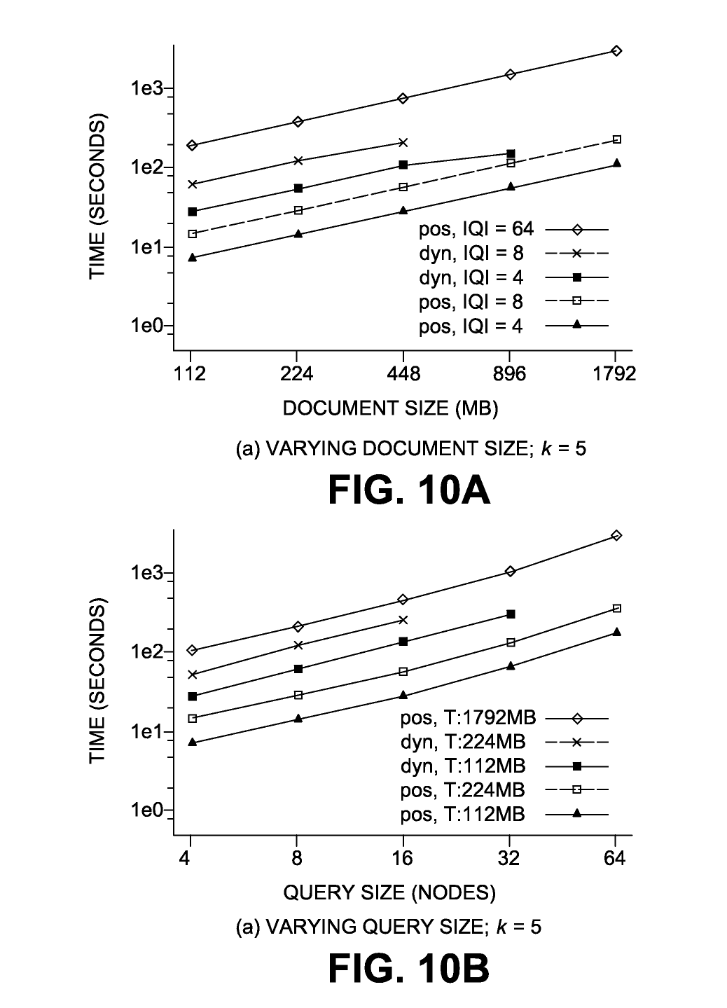

FIG. 11 compares the execution times of TASM-dynamic⁺ and TASM-dynamic. TASM-dynamic⁺ is, on average, 45% faster than TASM-dynamic since distance computations to large subtrees are pruned.

Main Memory Usage:

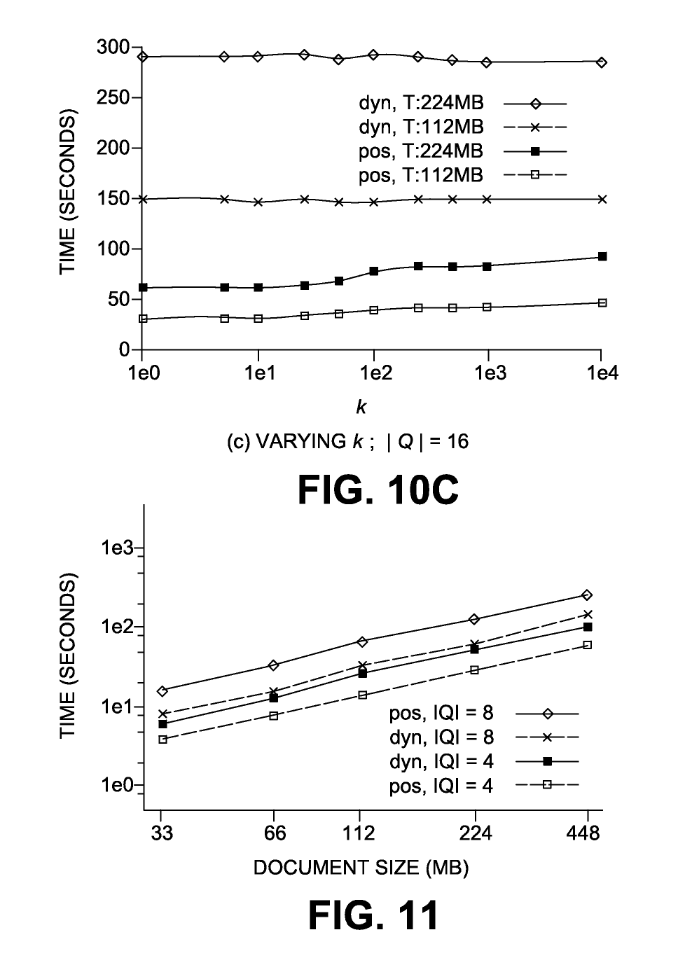

FIG. 12 compares the main memory usage of TASM-postorder and TASM-dynamic for different document sizes. The graph shows the average memory used by the Java virtual machine over 20 runs for each query and document size. (The memory used by the virtual machine depends on several factors and is not constant across runs.) It should be noted that plots for other query sizes were omitted since they follow the same trend as the ones shown in FIG. 12: the memory requirements are independent of the document size for TASM-postorder and linearly dependent on the document size for TASM-dynamic. In both cases the experiment agrees with our analysis. The missing points in the plot correspond to settings for which TASM-dynamic runs out of memory (4 GB). The difference in memory usage is remarkable: while for TASM-postorder only small subtrees need to be loaded to main memory, TASM-dynamic requires data structures in main memory that are much larger than the document itself.

In order to give a feel for the overall performance of TASM-postorder we compare its execution time against XQuery-based twig queries that find exact matches of the query tree. This can be seen as a very restricted solution to TASM and is the special case when k=1 and an identical copy of the query exists in the document. For example, query G in FIG. 2 can be expressed as follows:

for $v1 in //a[count(node( )) eq 2]
let $v2:=$v1/b[1][not (node( ))],
$v3:=$v1/c[1][not (node( ))]
where $v2 << $v3
return node-name($v1)

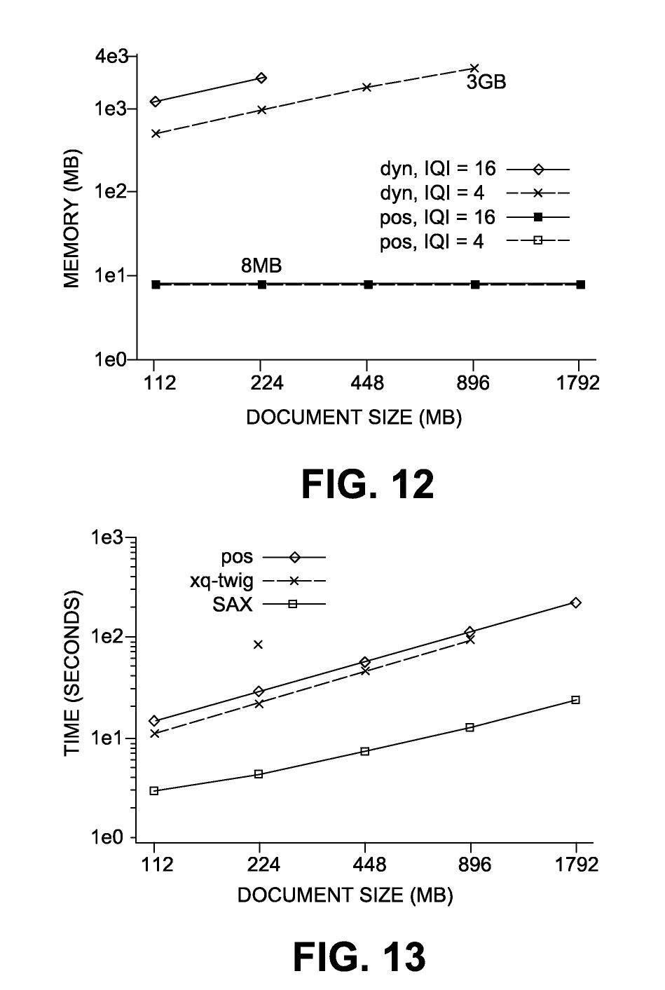

Saxon, a state-of-the-art main-memory, Java-based XQuery processor was used in the tests. FIG. 13 shows the results. As another reference point, the graph shows the cost of parsing each document using SAX. Compared to the XQuery program (xq-twig), TASM-postorder is on average only 26% slower. With respect to SAX, TASM-postorder is within one order of magnitude. xq-twig runs out of memory (4 GB) for larger documents and queries, whereas TASM-postorder does not. In summary, the performance of TASM-postorder compared to the special case of exact pattern matching is very encouraging.

Observe that TASM and twig matching are very different query paradigms and the runtime comparison presented above only serves as a reference. The twig query is an explicit definition of the set of all possible query answers; if there is no exact match, the result set is empty. In TASM, the query is a single tree pattern; all subtrees of the document are ranked, and even if there is no exact match, TASM will return the k closest matches. TASM does not substitute twig queries, but complements them and allows users to ask queries when they do not have enough knowledge about possible answers to define a twig query.

Provided below is an evaluation of the effectiveness of the prefix ring buffer pruning leveraged by TASM-postorder. Recall that the tree edit distance algorithm decomposes the input trees into relevant subtrees, and for each pair of relevant subtrees, Qᵢ and Tⱼ, a matrix of size |Qᵢ|times|Tⱼ| must be filled. The size and number of the relevant subtrees are the main factors for the computational complexity of the tree edit distance. TASM-dynamic incurs the maximum cost as it computes the distance between the query and every subtree in the document. In contrast, TASM-postorder prunes subtrees that are larger than a threshold.

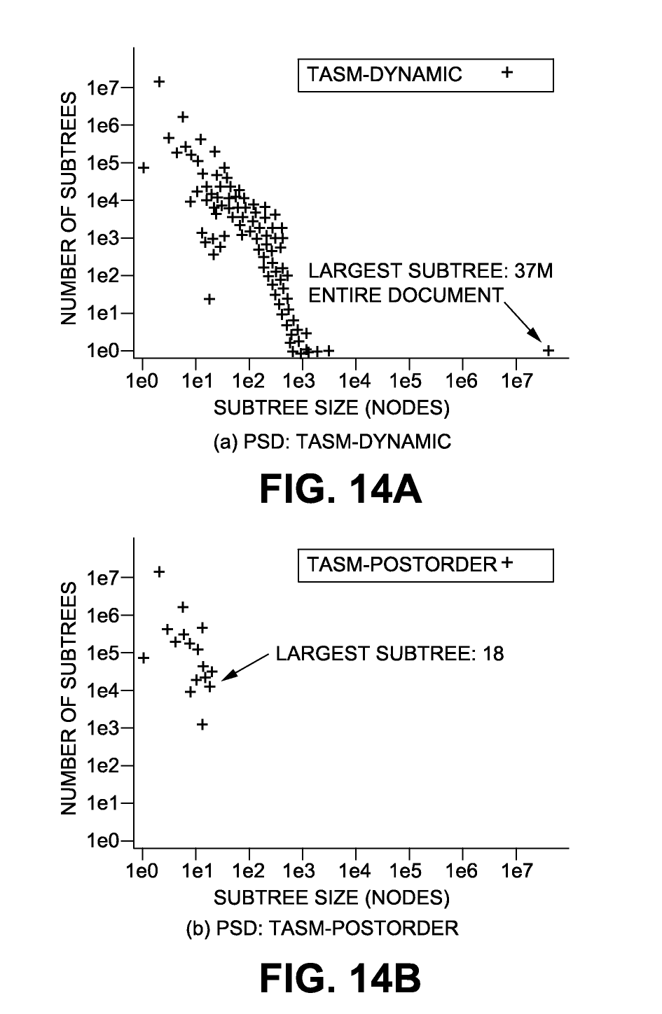

FIG. 14a shows the number of relevant subtrees (y-axis) of a specific size (x-axis) that TASM-dynamic must compute to find the top-5 ranking of the subtrees of the PSD7003 dataset for a query with |Q|=9 nodes. FIG. 14b shows the equivalent plot for TASM-postorder. The differences are significant: while TASM-dynamic computes the distance to all relevant subtrees, including the entire PSD document tree with 37M nodes, the largest subtree that is considered by TASM-postorder has only 18 nodes (while the theoretical maximum is 23). FIG. 14c shows a similar comparison for DBLP using a histogram. In the histogram, 1e1 shows the number of subtrees of sizes 0-9, 5e1 shows the sizes 10-49, 1e2 the sizes 50-99, etc. TASM-postorder computes much fewer and smaller trees: the bins for the subtree sizes 50 and larger are empty. It should be noted that the FIGS. 14a, 14b, and 14c, for TASM-dynamic do not depend on k, but they do for TASM-postorder. With k=1 for TASM-dynamic, the amount of virtual memory space required would be as large and would take as long to compute as any other value of k, for example, k=10. Such a discrepancy in the parameters used in the determination of the figures is not significant as one would imagine since TASM-dynamic always looks at subtrees the same way.

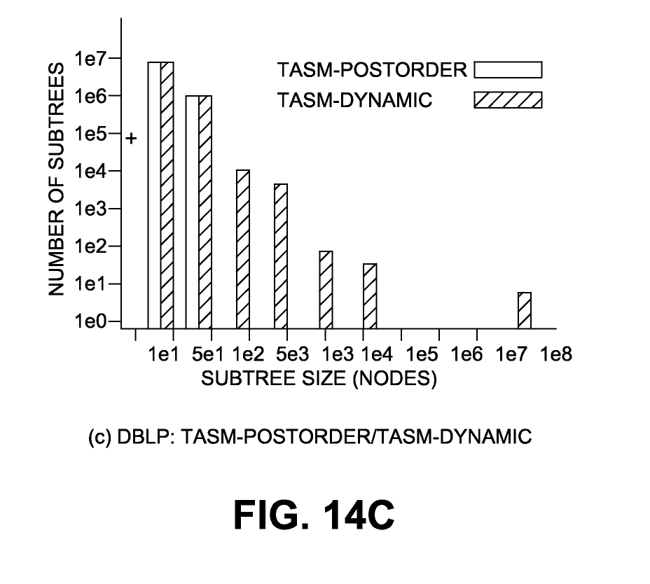

The subtrees computed by TASM-postorder are not always a subset of the subtrees computed by TASM-dynamic. If TASM-postorder prunes a large subtree, it may need to compute small subtrees of the pruned subtree that TASM-dynamic does not need to consider. Note, however, that every subtree that is computed by TASM-postorder is either computed by TASM-dynamic or contained in one that is. Thus TASM-dynamic is always more expensive. Define is the cumulative subtree size which adds the sizes of the relevant subtrees up to a specific size x that are computed by a TASM algorithm:

$$CSS ( x , T ) = {\sum }_{i = 1}^{x} {if}_{i} , 1 ≦ x ≦ \vert T \vert$$

where fᵢ is the number of subtrees of size i that are computed for document T. The difference of the cumulative subtree sizes of TASM-dynamic and TASM-postorder measures the extra computational effort for TASM-dynamic. In FIG. 15 we show the cumulative subtree size difference, css_{dyn}(x, T)−cssₚₒₛ(x, T), over the subtree size x for answering a top-1 query on the documents DBLP and PSD. For small subtrees the curves are negative, which means that TASM-postorder computes more small trees than TASM-dynamic. Nevertheless, TASM-dynamic ends up performing a considerably larger computation task than TASM-postorder. TASM-dynamic processes around 27M (129M) nodes more than TASM-postorder for the DBLP (PSD) document (660K resp. 89M excluding the processing of the entire document by TASM-dynamic in its final step).

Discussed above is TASM: the problem of finding the top K matches for a query Q in a document T w.r.t. the established tree edit distance metric. This problem has applications in the integration and cleaning of heterogeneous XML repositories, as well as in answering similarity queries. Also discussed is the state-of-the-art solution that leverages the best dynamic programming algorithms for the tree edit distance and characterized its limitation in terms of memory requirements: namely, the need to compute and memorize the distance between the query and every subtree in the document. Proved above is an upper bound on the size of the largest subtree of the document that needs to be evaluated. This size depends on the query and the parameter k alone. Also provided is an effective pruning strategy that uses a prefix ring buffer and keeps only the necessary subtrees from the document in memory. As a result, provided is an algorithm that solves TASM in a single pass over the document and whose memory requirements are independent of the document itself. The analysis is verified experimentally and showed that the solution scales extremely well w.r.t. document size, query size, and the parameter k.

The above solution to TASM is portable. It relies on the postorder queue data structure which can be implemented by any XML processing or storage system that allows an efficient postorder traversal of trees. This is certainly the case for XML parsed from text files, for XML streams, and for XML stores based on variants of the interval encoding, which is prevalent among persistent XML stores. The present invention opens up the possibility of applying the established and well-understood tree edit distance in practical XML systems.

As noted above, the present invention can be used in searching databases, documents, anything that can be represented by a tree structure. As well, queries are, preferably, representable in a tree structure as well.

The method or algorithmic steps of the invention may be embodied in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The following references are useful for a better understanding of the present invention.
[1] S. Guha, H. V. Jagadish, N. Koudas, D. Srivastava, and T. Yu, “Approximate XML joins,” in SIGMOD, 2002, pp. 287-298.
[2]S. Melnik, H. Garcia-Molina, and E. Rahm, “Similarity flooding: A versatile graph matching algorithm and its application to schema matching,” in ICDE, 2002, pp. 117-128.
[3]N. Augsten, M. H. Böhlen, C. E. Dyreson, and J. Gamper, “Approximate joins for data-centric XML,” in ICDE, 2008, pp. 814-823.
[4]E. Rahm and P. A. Bernstein, “A survey of approaches to automatic schema matching.” VLDB J., vol. 10, no. 4, pp. 334-350, 2001.
[5]M. Weis and F. Naumann, “Dogmatix tracks down duplicates in XML,” in SIGMOD, 2005, pp. 431-442.
[6]N. Agarwal, M. G. Oliveras, and Y. Chen, “Approximate structural matching over ordered XML documents,” in IDEAS, 2007, pp. 54-62.
[7]L. Guo, F. Shao, C. Botev, and J. Shanmugasundaram, “XRANK: Ranked keyword search over XML documents,” in SIGMOD, 2003, pp. 16-27.
[8]K.-C. Tai, “The tree-to-tree correction problem,” J. of the ACM, vol. 26, no. 3, pp. 422-433, 1979.
[9]K. Zhang and D. Shasha, “Simple fast algorithms for the editing distance between trees and related problems,” SIAM J. on Computing, vol. 18, no. 6, pp. 1245-1262, 1989.
[10] I. F. Ilyas, G. Beskales, and M. A. Soliman, “A survey of top-k query processing techniques in relational database systems,” ACM Computing Surveys, vol. 40, no. 4, 2008.
[11] S. Amer-Yahia, N. Koudas, A. Marian, D. Srivastava, and D. Toman, “Structure and content scoring for XML,” in VLDB, 2005, pp. 361-372.
[12] A. Marian, S. Amer-Yahia, N. Koudas, and D. Srivastava, “Adaptive processing of top-k queries in XML,” in ICDE, 2005, pp. 162-173.
[13] M. Theobald, H. Bast, D. Majumdar, R. Schenkel, and G. Weikum, “TopX: Efficient and versatile top-k query processing for semistructured data,” VLDB J., vol. 17, no. 1, pp. 81-115, 2008.
[14] M. S. Ali, M. P. Consens, X. Gu, Y. Kanza, F. Rizzolo, and R. K. Stasiu, “Efficient, effective and flexible XML retrieval using summaries,” in INEX, 2006, pp. 89-103.
[15] Z. Liu and Y. Chen, “Identifying meaningful return information for XML keyword search,” in SIGMOD, 2007, pp. 329-340.
[16] R. Kaushik, R. Krishnamurthy, J. F. Naughton, and R. Ramakrishnan, “On the integration of structure indexes and inverted lists,” in SIGMOD, 2004, pp. 779-790.
[17] R. Fagin, A. Lotem, and M. Naor, “Optimal aggregation algorithms for middleware,” J. of Computer and System Sciences, vol. 66, no. 4, pp. 614-656, 2003.
[18] E. D. Demaine, S. Mozes, B. Rossman, and O. Weimann, “An optimal decomposition algorithm for tree edit distance,” in ICALP, ser. LNCS, vol. 4596.1em plus 0.5em minus 0.4emSpringer, 2007, pp. 146-157.
[19] D. Barbosa, L. Mignet, and P. Veltri, “Studying the XML Web: Gathering statistics from an XML sample,” World Wide Web J., vol. 8, no. 4, pp. 413-438, 2005.
[20] R. Yang, P. Kalnis, and A. K. H. Tung, “Similarity evaluation on tree-structured data,” in SIGMOD, 2005, pp. 754-765.
[21] N. Augsten, M. Böhlen, and J. Gamper, “The pq-gram distance between ordered labeled trees,” ACM Transactions on Database Systems, vol. 35, no. 1, 2010.
[22] J. R. Ullmann, “An algorithm for subgraph isomorphism,” J. of the ACM, vol. 23, no. 1, pp. 31-42, 1976.
[23] Y. Tian and J. M. Patel, “TALE: A tool for approximate large graph matching,” in ICDE, 2008, pp. 963-972.
[24] I. Tatarinov, S. D. Viglas, K. Beyer, J. Shanmugasundaram, E. Shekita, and C. Zhang, “Storing and querying ordered XML using a relational database system,” in SIGMOD, 2002, pp. 204-215.
[25] A. Schmidt, F. Waas, M. L. Kersten, M. J. Carey, I. Manolescu, and R. Busse, “XMark: A benchmark for XML data management,” in VLDB, 2002, pp. 974-985.
[26] M. Kay, “Ten reasons why saxon xquery is fast,” IEEE Data Eng. Bull., vol. 31, no. 4, pp. 65-74, 2008.

The embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g.“C”) or an object-oriented language (e.g.“C++”, “java”, or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above, all of which are intended to fall within the scope of the invention as defined in the claims that follow.

Having thus described the invention, what is claimed as new and secured by Letters Patent is:

1. A method for sorting nodes in a document tree to determine a number of closest approximations to a query represented by a query tree, the method comprising:
a) determining a limit size of subtrees of said document tree to be considered;
b) determining candidate subtrees of said document tree, each candidate subtree of said document tree having a size equal to or less than said limit size and each candidate subtree is not a subtree of another subtree having a size less than or equal to said limit size;
c) for each candidate subtree, determining a tree edit distance between said candidate subtree and said query tree;
d) sorting candidate subtrees in accordance with their respective tree edit distances with said query tree, in order to determine which candidate subtrees have least tree edit distances with said query tree;
wherein said tree edit distance is a cost to convert contents of one subtree into contents of a second subtree.

2. A method according to claim 1 wherein said candidate subtrees are stored in a memory buffer.

3. A method according to claim 1 wherein subtrees of candidate subtrees are removed from consideration as candidate subtrees.

4. A method according to claim 2 wherein said memory buffer is a ring buffer.

5. A method according to claim 2 wherein a number of nodes which can be stored in said memory buffer is equal to or less than said limit size.

6. A method according to claim 1 wherein said nodes are processed in an order such that the root node of said document tree is processed last.

7. A method according to claim 1 wherein only candidate subtrees which exist in the document tree are processed for step c).

8. Computer-readable media having encoded thereon computer readable and computer executable instructions which, when executed, executes a method for sorting nodes in a document tree to determine a number of closest approximations to a query represented by a query tree, the method comprising:
a) determining a limit size of subtrees of said document tree to be considered;
b) determining candidate subtrees of said document tree, each candidate subtree of said document tree having a size equal to or less than said limit size and each candidate subtree is not a subtree of another subtree having a size less than or equal to said limit size;
c) for each candidate subtree, determining a tree edit distance between said candidate subtree and said query tree;
d) sorting candidate subtrees in accordance with their respective tree edit distances with said query tree, in order to determine which candidate subtrees have least tree edit distances with said query tree;
wherein said tree edit distance is a cost to convert contents of one subtree into contents of a second subtree.

9. Computer-readable media according to claim 8 wherein said candidate subtrees are stored in a memory buffer.

10. Computer-readable media according to claim 8 wherein subtrees of candidate subtrees are removed from consideration as candidate subtrees.

11. Computer-readable media according to claim 9 wherein said memory buffer is a ring buffer.

12. Computer-readable media according to claim 9 wherein a number of nodes which can be stored in said memory buffer is equal to or less than said limit size.

13. Computer-readable media according to claim 8 wherein said nodes are processed in an order such that the root node of said document tree is processed last.

14. Computer-readable media according to claim 8 wherein only candidate subtrees which exist in the document tree are processed for step c).

15. A method for determining which subtrees in a document tree most closely approximate a given query tree, the method comprising:
a) determining a limit size of subtrees of said document tree to be considered;
b) determining candidate subtrees of said document tree, each candidate subtree of said document tree being, at most, equal in size to said limit size;
c) for each candidate subtree, determining a cost to convert contents of said candidate subtree into contents of said query tree;
d) sorting candidate subtrees in accordance with costs for converting said candidate subtrees into said query tree,
e) determining which candidate subtrees have lowest costs for converting said candidate subtrees into said query tree, candidate subtrees having lowest costs for being converted into said query tree being subtrees which most closely approximate said query tree.

16. A method according to claim 15 wherein subtrees which are a subtree of another subtree having a size which is, at most, equal to said limit size are excluded from being a candidate subtree.

17. A method according to claim 15 further comprising the step of determining which candidate subtrees exist in said document tree.

18. A method according to claim 17 wherein candidate subtrees which do not exist in said document tree are not processed according to step c).

19. A method according to claim 15 wherein candidate subtrees are stored in a ring buffer.

20. A method according to claim 19 wherein unsuitable candidate subtrees are pruned from said buffer.
